(19) United States
(12) Patent Application Publication
(10) Pub. No.: US 2022/0284199 A1
(43) Pub. Date: Sep. 8, 2022

(54) SYSTEM AND METHOD FOR DETERMINING THE CONDITION OF AN ARTICLE

(71) Applicants: Michael Arno, East Amherst, NY (US); John A. Carlin, East Amherst, NY (US); Tyler Arno, East Amherst, NY (US)

(72) Inventors: Michael Arno, East Amherst, NY (US); John A. Carlin, East Amherst, NY (US); Tyler Arno, East Amherst, NY (US)

(21) Appl. No.: 17/190,220

(22) Filed: Mar. 2, 2021

(51) Int. Cl. G06K 7/10; G06K 19/077

(52) U.S. Cl. CPC G06K 7/10297; G06K 19/07758

(57) ABSTRACT

A system and method for determining whether an article is new or used; and if used, the extent of usage. A smart tag, or smart tag, integrates into the article. The smart tag has integrated therein, data, which related to the article. A tag reader communicates a query to the smart tag to obtain the data. A non-volatile memory contains the item manufacturer, a serial number, and an item identity. A one-time-activation circuit determines if the article is ‘NEW’ or ‘USED’. A sensing element contains a ‘wakeup’ process to respond to a query, or, to monitor and log usage. Usage is categorized to a density, a sequence, an interval, and an amplitude algorithm of movement as being representative of the scale of usage. This data stores in the non-volatile memory. A tag reader, or tag reader queries the smart tag to access the logged data.

### FIELD OF THE INVENTION

The present disclosure relates generally to a system and method for determining the condition of an article. More so, the present invention relates to a system that determines whether an article satisfies a predetermined criterion, such as if the article is new or used, and if used, how much usage the article has experienced; whereby a smart tag integrates into the article, and a sensing element is configured to read the smart tag to obtain data that is indicative of whether the condition of the article satisfies the at least one predetermined criterion.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

In the subject of manufactured articles, such as a sneaker, a shoe, a woman's handbag or dress, a leather jacket, a bicycle, pair of skis, etc., there are many opportunities for the sale or resale of such items. Further, such articles can be considered new, if sold as original goods but there is no means to really tell if in fact the article is new. Or as used goods, previously bought but there is no means to really tell in fact, how much usage the item has; wear-and-tear. The act or an instance of selling again specifically, a new purchaser of such goods, are left in complete unawareness of usage the item has experienced. This is despite that some used articles can resell for many hundreds, even several thousands of dollars. The new buyer purchases the goods on faith alone as to the usage or newness of the original, as being proper. The present disclosure relates specifically to an apparatus, system and method to determine the newness, the ‘mint’ if you will, i.e., the usage of goods; where the article of goods is genuinely new or used, and, if used how much.

Articles bought and sold as new can also not authentically be new, and an unaware buyer pays for something thinking it was so-called brand-new. Automobiles for example have odometers; that can immediately identify if the vehicle is in fact ‘new’ or not, and if not new, how many miles it was driven; an indicator of usage. This is true notwithstanding no matter how ‘clean’ the vehicle's appearance is, and how convincing the salesperson may be. Odometers make purchasing a car, new or used, genuinely authentic as to the usage of the vehicle, and an excellent means to fully understand exactly the principle of usage.

Other articles, such as the sneakers or apparel, as was earlier mentioned, or goods of any category, can be sold and re-sold without any accountability as to being genuinely authentic. Purchasers of goods are completely at the advantage of the seller. Manufacturers are also left to the trust that their goods are being sold as an authentic item by retailers. Unscrupulous retailers may be selling counterfeit articles under a genuine manufacturer's name. Further, the retailer too could be duped in thinking they are selling real genuine articles when they have only received fake manufactured items, as genuine. In all these scenarios, many buyers have been victims for decades; purchasing goods thinking that they are authentic genuine articles that are new and by the labeled manufacturer. And likewise, for a used item the purchaser is left to luck, as to the usage or newness of an item.

There is a need to practically monitor articles that are purchased in two ways. First, is the item new? And second, if not new identify exactly the mint, the authentic genuine manufacturer, and degree of usage the item has experienced. The requirement for these, should include a means for anyone, to electronically query such articles, and have an immediate response of identification if the article is in fact ‘new’ or not, and if not new, an indication of how much use the item as experienced.

With regard to the present disclosure, for simplicity, the inventors will use as an example a conventional athletic shoe (a sneaker), a ‘ladies’ handbag and dress, a leather jacket, a bicycle, or a pair of skis, as examples of articles to explain the functionality of the present invention. The apparatus of the present invention is manufactured into said articles, and once activated, would operate for the life of the article, and, cannot be reset or deactivated. Remember the scenario of the odometer in a vehicle above? The vehicle odometer is at ‘zero’ miles when manufactured (and maybe see five or ten miles in testing and delivery of the vehicle to an auto dealer) but is considered being NEW. From there on, for example 2,000 or 200,000 miles are degrees of usage, wear and tear, and more precisely, being ‘USED’ and how much. The system and method of the present disclosure is like this functionality (of an odometer in a vehicle) but instead of counting miles, has other measurement quantifiers to express usage.

The following prior art has been identified: US2019/0082756 to Arno relates to illuminating placards on apparel and other gear, with controlled color display via a smartphone. US2019/0310102 to Liu et al. discloses a pedometer shoe having a vamp (upper front part of a shoe) and a sole which are connected and sending out signals according to step counts. US2017/0325538 to Hsieh et al. relates to a step-counting shoe, having a pedometer to detect the number of steps. US2016/0349076 to Campos Gallo et al. discloses a means for a biomechanical, nanopedometer to step counting and the measurement of information parameters of an insole of a shoe or sneaker. US2015/02337126 to Haslacher et al. discloses a system for counting shoe and uploading data to a centralized server, wherein the shoe may be placed on a charging station.

Continuing with prior art disclosure, US2013/0247424 to Tseng discloses a step-counting shoe having its own power generation of electrical energy during user walking. US2013/0028368 to Oshio discloses a pedometer mountable on a shoe, producing an electrical current when shoe is ‘landed’ (to the ground) by pressure, to signal outside the shoe and perform counting. US2007/0033838 to Luce et al. relates to a shoe wear indicator, wherein the user inserts the device in their athletic shoe, and, can remove it to then connect to a terminal for downloading shoe usage data; the result being to determine the useful life of the shoe and for replacement. US2007/0169381 to Gordon discloses a shoe suited for walking or running pedometer that can indicate when the shoe should be replaced (to protect against skeletal, bone, etc., injury) due to diminished shock absorbency.

Each of the above disclosures teaches a means to count steps, to determine useful life, to recommend replacement and to display colored illumination on the apparel. None of the above approaches in the prior art discloses a means for measuring the article for being new, and, if not new, an indication of how much use it has experienced. None of the prior art approaches have an authenticity means to in effect determine that the article is a genuine manufactured item (not a fake), that can be useful in giving a purchaser of an original sale, or the potential re-users, in the reselling of the item, to insure the legitimacy of the article. And finally, none of the prior art has a system to ‘thread’ all the information derived to an original manufacturer, back to the manufacturer serialized product production.

Other proposals have involved systems and methods for determining the condition of an article. The problem with these gripping devices is that they do not employ a smart tag directly into the article. Also, the usage data and the authentic original manufacturer serial number of the article are not readable from the smart tag. Even though the above cited systems and methods for determining the condition of an article meets some of the needs of the market, a system and method to determine condition of an article. More so, the present invention relates to a system that determines whether an article satisfies a predetermined criterion, such as if the article is new or used, and if used, how much usage the article has experienced; whereby a smart tag integrates into the article, and a sensing element is configured to read the smart tag to obtain data that is indicative of whether the condition of the article satisfies the at least one predetermined criterion, is still desired.

### SUMMARY

Illustrative embodiments of the disclosure are generally directed to a system and method for determining the condition of an article. The system is configured to determine whether an article satisfies a predetermined criterion, such as if the article is new or used, and if used, how much usage the article has experienced. A smart tag integrates into the article. The smart tag has integrated therein, article data, which is pertinent to the article, including manufacture data, shipping date, and purchase information, if any. A sensing element is configured to read the smart tag, in order to obtain the data. The data is indicative of whether the condition of the article satisfies the at least one predetermined criterion. In essence, the system for determining the condition of an article is useful for providing a tamper-proof means to determine the following data from a smart tag integrated in the article: the original manufacturer, the date of manufacture, the condition of the article, i.e., new or used, and the extent of usage the article has experienced, or said another way, the life of the article. This data may be queried from a data storage unit for easy access and digestion.

A system for determining the condition of an article, comprises a smart tag having a non-volatile memory operable to store data related to an article, the data including at least one of the following: an article identity, a manufacturer, a serial number, and a date the smart tag attaches to the article.

The smart tag also has a sensor element operatively connected to the non-volatile memory, the sensor element operable to detect a motion of the smart tag, the sensor element further being operable to log usage of the article if the duration of the motion exceeds a predetermined duration or intensity parameter.

The sensor element includes a wake-up circuit operable to generate a wake-up signal upon detection of a query, the wake-up signal operable to enable retrieval of the data in the non-volatile memory in response to the query, the wake-up signal further being operable to enable logging usage of the article into the non-volatile memory.

The smart tag also has a one-time-activation circuit operatively connected to the sensor element, the one-time-activation circuit operable to indicate that the article is new if the duration of the motion does not exceed the duration or intensity parameter , the one-time-activation circuit further being operable to indicate that the article is used if the duration of the motion exceeds the duration or intensity parameter.

The system also comprises a tag reader operable to wirelessly communicate with the smart tag, the tag reader further being operable to initiate the query, the tag reader further being operable to display the queried data from the non-volatile memory, the tag reader further being operable to display whether the article is new or used.

In another aspect, the smart tag is hermetically sealed.

In another aspect, the smart tag includes at least one of the following: a micro-controller, a processor, and a firmware program.

In another aspect, the article identity includes at least one of the following: an apparel, an accessory, a footwear, and a mechanism.

In another aspect, the sensor element comprises an ultra-low-power high-performance 3-axis accelerometer.

In another aspect, if the duration of the motion exceeds the predetermined duration or intensity parameter, the sensor element logs usage of the article.

In another aspect, the communication between the smart tag and the tag reader is a serial data-stream.

In another aspect, the movement is categorized as a density, a sequence, an interval, and an amplitude algorithm of movement.

In another aspect, the density comprises the intensity of the motion of the smart tag.

In another aspect, the sequence comprises a tally of the repetition of motion of the smart tag.

In another aspect, the interval comprises the time between different motions by the smart tag;

In another aspect, the amplitude comprises the strength of the motion of the smart tag.

In another aspect, the system comprises a sensor control operatively connected to the sensor element, the sensor control operable to regulate the sensor element.

In another aspect, the system further comprises a battery.

In another aspect, the battery is in a deep sleep mode if there is no query.

In another aspect, the tag reader operable to wirelessly exchange the data with the smart tag through an NFC protocol.

A method for determining the condition of an article, comprises an initial Step of attaching a smart tag to an article, the smart tag comprising a non-volatile memory, a sensor element operatively connected to the non-volatile memory and having a wake-up circuit, and a one-time-activation circuit operatively connected to the sensor element.

Another Step comprises loading data related to the article on the non-volatile memory.

Yet another Step may include detecting, with the sensor element, a motion of the smart tag.

The method also includes a Step of logging, by the sensor element, usage of the article if the duration of the motion exceeds a predetermined duration or intensity parameter.

Another Step comprises indicating, by the one-time-activation circuit, that the article is new if the duration of the motion does not exceed the duration or intensity parameter.

Yet another Step may include indicating, by the one-time-activation circuit, that the article is at least partially depleted if the duration of the motion exceeds the duration or intensity parameter.

The method also includes a Step of initiating, by a tag reader, a query for the data.

A final Step comprises enabling, by the wake-up signal, retrieval of the data in the non-volatile memory in response to the query.

The system and method of the present disclosure of a usage monitor, can be deliberately adapted to sense usage once activated. This is accomplished at the ‘point-of-sale’ of an original article (fully authorized by a manufacturer), by the tag reader running a special version of the APPLICATION that allows the activation of the tag. The act of activating the usage monitor (that can never be reset) must be intentional, not an arbitrary ‘movement’ that may be caused by the item being transported or a customer simply reviewing it in consideration to purchase. And once activated, the smart tag can never be reset or deactivated. Can be powered by a wireless rechargeable battery. Can accumulate logged usage data and relate such data when queried along with authentic original manufacturer serial number. Can be virtually manufactured in any article that can experience wear-and-tear, be it an apparel item, an accessory item, a shoe item, a mechanical object, a garment of any kind, a household good, etc. According to the present disclosure, the apparatus, system and method of usage measuring device, will give a buyer of original ‘NEW’ goods, resale purchasers of ‘USED’ goods, and, the manufacturers and their distributers and retailers, all the confidence that said goods are genuinely authentic new and if not new then used and how much usage the item has experienced.

Illustrative embodiments of the disclosure are generally directed to a self-contained hermetically sealed electronic micro-controller for usage monitoring, embedded into an article at time of manufacture. The electronic micro-controller is activated at point of original sale, and can never be turned-off, reset or deactivated (tamper-proof). Unit is designed for long life (with long lasting batteries) or powered by wireless power transmission (WPT) to charge a rechargeable battery. Even replaceable batteries for some embodiments could be used. Usage sensing determines degrees of usage and is accumulated and logged in non-volatile memory. Anyone can access the stored accumulated logged data, along with original manufacturer serial number and product identification, via an appropriate application (APP) designed for the task; to ascertain the authenticity of the article, its state of being new, and, if not new, being used, and the extent of use. Embodiments include high-end versions, whereby it is intended for pricy goods that could last literally for decades, and a simpler version for lower-cost articles; that are mostly common shorter-lived items.

Throughout this disclosure, conventional components such as printed circuit boards (PCB's), micro integrated circuits, application specific integrated circuits (ASIC) chips, non-volatile memory (ROM, EPROM, EEPROM, FLASH, and the like), field programable gate array (FPGR), Radio-frequency identification (RFID), proximity wireless data communications (Near Field Communications) or carrier signal transmission of data, batteries and recharging techniques (such as wireless power transmission), sensing means, accelerometer, rolling-ball, tilt-switch or other motion detection techniques, hermetically sealed encapsulating techniques, application (APP) techniques, and the like, etc., are not discussed in details (in terms of their wiring in a circuit layout and mechanics or any other physical properties); because all these items are well known for their use and understood by anyone skilled in the art of electrical circuitry design, or their electrical or mechanical benefits. It is explicitly understood that any configuration of such electrical component means (as listed above or other controlling devices) can be applied to the teachings of the present disclosure, and, have benefit as to achieving a self-contained hermetically sealed electronic micro-controller for usage monitoring.

In one embodiment of a self-contained hermetically sealed electronic micro-controller for usage monitoring. Wherein, said micro-controller is a self-contained electronic unit comprising a processor, a firmware program, a non-volatile memory for data storage of logged usage, a sensing element, communications, and a battery power. The apparatus is intended to be embedded into manufactured articles at the time of manufacture.

In another embodiment of a self-contained hermetically sealed electronic micro-controller for usage monitoring is including a rechargeable means for a rechargeable battery.

In one other embodiment, the self-contained hermetically sealed electronic micro-controller for usage monitoring can store a manufacturer's serial number and product identity.

Still a further embodiment of a self-contained hermetically sealed electronic micro-controller for usage monitoring is embedded into an apparel item, an accessory item, a footwear item, or a mechanized item, as beneficial to monitor and log usage of said article.

In another embodiment of the system, a charging station is utilized to charge a wireless power transmission (WPT) for a re-chargeable battery, whereby inductive coupling, or resonance inductive coupling (RIC), recharging of the battery is accomplished at any time that the article, containing the smart tag, is in close proximity to the said charging station, said charging station can further facilitate communications via a carrier signal transmitted between the smart tag and the tag reader, of the serial data-stream as the apparatus is being charged.

In another aspect, the sensing element is one or more of motion detection means as a rolling ball switch, an accelerometer, a proximity magnetic switch, or a strain gauge means to detect movement of the article. Said movement representing usage, and if not moving then its quiescent position is considered dormant.

In another aspect, the sensing element(s) detects movement of the article and said movement is analyzed and categorized to a density, a sequence, an interval, and an amplitude algorithm of movement as being representative of the scale of usage.

In another aspect, the one-time-activation process determines if the article, an apparel item, an accessory item, a footwear item, or a mechanized item, that the apparatus is embedded/installed into during manufacturing, is ‘NEW’ or ‘USED’, and, if determination is ‘USED’, then log activity events represents the degree of usage as a density, a sequence, an interval, and an amplitude in an algorithm as being representative of the degree of usage the article has experienced as wear-and-tear.

In another aspect, the wear-and-tear further is a pseudo clock representing usage/days of operation logged and stored in non-volatile memory, whereby the usage/day is represented as an event of the article being used

One objective of a self-contained hermetically sealed electronic micro-controller for usage monitoring is to have the micro-controller begin in a dormant state. Wherein said dormant state can be activated by a wireless signal designated for starting the device to monitor usage at time of original sale.

One other objective of a self-contained hermetically sealed electronic micro-controller for usage monitoring is to sense movement, wherein a movement sensing means is a shorting-conductor that travels between electrodes as movement happens.

One further objective to sense movement is via a magnet and the magnetic disturbance, wherein the flux changes due to the article's parts being moved about.

One other objective is to sense movement via an accelerometer to determine an article is at rest or traveling.

Still another objective for sensing movement is a tilt-switch, whereby a ‘rolling ball’ is the movement detecting means to determine an article is at rest or traveling.

Another objective sense movement, wherein a movement sensing means is a strain gauge. Whereby, said strain gauge can detect the ‘flexing’ (bending, stretching, expanding, contracting, etc.) micro movements of materials in the article where the apparatus is being embedded.

Another objective of a self-contained hermetically sealed electronic micro-controller for usage monitoring, is to have stored in non-volatile memory, accumulated events of detected movements. Whereby, every event adds to an ever-growing accumulated number.

Another objective of the stored usage of monitoring structure is to create an internal clock, wherein a pseudo day is derived, and, said pseudo-usage/day could be the usage event that is stored in the non-volatile memory.

Still another objective of a self-contained hermetically sealed electronic micro-controller for usage monitoring is to organize the stored logs of usage with every detected event, to represent wear and tear; wherein an event density, a sequence, an interval, and an amplitude of process signals are logged as usage.

One further objective a self-contained hermetically sealed electronic micro-controller for usage monitoring to register any sensed movement and interpret such movement as a usage. Whereby the list of usage would further detail the manufacturers serial number and identity, activation status (if not activated, indicate NEW) if activated register current usage; all in non-volatile memory in a coded form of storage.

Yet another registering technique, list the total accumulated logged usage score value, or, to list the pseudo clock daily representation of usage as compared to days from being activated, or both, for storage in non-volatile memory in coded form.

One other a self-contained hermetically sealed electronic micro-controller for usage monitoring is to respond to a query. Wherein said query response is a serial coded data-stream to efficiently transmit the info, in response to a query from an external application (APP) to decode said data-stream and list and display the current status of monitored usage on a tag reader.

Another objective of a self-contained hermetically sealed electronic micro-controller for usage monitoring, is to have a revision-controlled hardware and firmware process to iterate so the data-stream of usage info will always be able to decode and display on a tag reader, via the APP.

Finally, an objective of a self-contained hermetically sealed electronic micro-controller for usage monitoring is when, the rechargeable battery may not be charged, and the battery is completely depleted. Upon a recharge, the depleted event is registered as an event in the experience of the life of the article. Whereby, should subsequent power depletions occur, number of accumulative events is registered and logged (in the non-volatile memory) as to the number of such events having occurred.

The present disclosure takes advantage of all these embodiments and objectives listed making them easy to apply a self-contained hermetically sealed electronic micro-controller for usage monitoring. The embodiments presented, use these objectives to result in a process to monitor usage, store the logged monitored usage in coded form in non-volatile memory, and list registered usage events when queried via coded and decoded data-stream of transmission to a tag reader for display and review. The apparatus of a self-contained hermetically sealed electronic micro-controller for usage monitoring is powered for relative short spans of time (few years) to decades of monitoring via wireless power transmission to recharge a rechargeable battery; configured for any particular type of article that the apparatus is embedded, i.e., inexpensive common articles (typically of short usage life), to high-end pricy articles where it is desired to track the usage over longer periods of time and span of usage.

Disadvantages of prior art listed earlier are overcome, with respect to their inability to do anything other than count steps (when walking for example), in that they have no means for a self-contained hermetically sealed electronic micro-controller for usage monitoring and log events for the express purpose to determine if an article is NEW or USED, and, if used how much. To further determine a manufacturers serial number and identity, an activation process to bring alive the apparatus to start usage monitoring, an accumulate registration of events, and list a numbers of pseudo days activated in determining wear-and-tear.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims and drawings.

### BRIEF DESCRIPTION OF THE DRAWINGS

The invention will now be described, by way of example, with reference to the accompanying drawings, in which:

FIG. 1 is a block diagram of an exemplary system for determining the condition of an article, in accordance with some embodiments of the present disclosure;

FIG. 2 is a flowchart of an exemplary method for determining the condition of an article, in accordance with some embodiments of the present disclosure;

FIG. 3 is a block diagram of an exemplary system for a self-contained hermetically sealed electronic micro-controller for a smart tag having a re-chargeable battery, in accordance with some embodiments of the present disclosure;

FIG. 4 is a block diagram of an alternate embodiment system for a self-contained hermetically sealed electronic micro-controller for a smart tag and having a non-rechargeable battery, in accordance with embodiments of the subject matter described herein;

FIG. 5a is an isometric view of a self-contained hermetically sealed electronic micro-controller for a smart tag that is encapsulated with components as described in the diagram of FIG. 1, in accordance with some embodiments of the present disclosure;

FIG. 5b is an illustration showing the smart tag of FIG. 5a, being manufactured into an apparel item, in accordance with some embodiments of the present disclosure;

FIG. 5c is an illustration showing the smart tag of FIG. 5a, being manufactured into an accessory item, in accordance with some embodiments of the present disclosure;

FIG. 6a is an illustration showing the smart tag of FIG. 5a, being manufactured into a footwear item, and, a charging station, whereby an article can also communicate, in accordance with some embodiments of the present disclosure;

FIG. 6b is an illustration showing the smart tag of FIG. 5a, being manufactured into a footwear item, a charging station, and a tag reader, in accordance with some embodiments of the present disclosure;

FIG. 7a is an isometric view of a self-contained hermetically sealed electronic micro-controller for an alternate embodiment of the smart tag that is encapsulated with components as described in the diagram of FIG. 4, in accordance with an embodiment of the subject matter described herein;

FIG. 7b is an illustration showing the smart tag of FIG. 7a, being manufactured into an accessory item, and a tag reader, in accordance with embodiments of the subject matter described herein;

FIG. 8 is an illustration showing the smart tag of FIG. 5a, being manufactured into a mechanized item and featuring one means of motion sensing and detection, in accordance with some embodiments of the present disclosure;

FIG. 9 is a flow chart diagram showing the operational process of the present invention, in accordance with an embodiment of the present disclosure;

FIG. 10a shows an example of the tag reader, running an application and displaying a representation of a usage screen showing data obtained from the smart tag of FIG. 6b, in accordance with an embodiment of the present disclosure;

FIG. 10b shows an example of the tag reader, running an application and displaying a representation of a usage screen showing ONE-TIME-ACTIVATION means for the smart tag of FIG. 1, in accordance with an embodiment of the present disclosure;

FIG. 11a shows an example of the tag reader, running an application and displaying a representation of a usage screen showing viewing a detail of data obtained from the smart tag of FIG. 6b, in accordance with an embodiment of the present disclosure;

FIG. 11b shows an example of the tag reader, running an application and displaying a representation of a usage screen showing viewing a power management detail of data obtained from the smart tag of FIG. 3, in accordance with an embodiment of the present disclosure;

FIG. 12 is a Table of multiple coded serial data-streams, in accordance with an embodiment of the present disclosure;

FIG. 13 is a flow diagram showing the process of a WAKE-UP routine of the self-contained hermetically sealed electronic micro-controller for a smart tag, and, the ONE-TIME-ACTIVATION routine, in accordance with an embodiment of the present disclosure;

FIG. 14 is a flow diagram showing a QUERY (to upload logged events) and SENSOR ACTIVE (to store logged events) routines of the self-contained hermetically sealed electronic micro-controller for a smart tag, in accordance with an embodiment of the present disclosure;

FIG. 15 is a flow diagram showing the process of a LOAD and INITIALIZE routines of the self-contained hermetically sealed electronic micro-controller for a smart tag, during the manufacturing process, and the testing thereof, in accordance with an embodiment of the present disclosure; and

FIG. 16 is a block diagram depicting an exemplary client/server system, in accordance with an embodiment of the present disclosure.

Like reference numerals refer to like parts throughout the various views of the drawings.

### DETAILED DESCRIPTION OF THE INVENTION

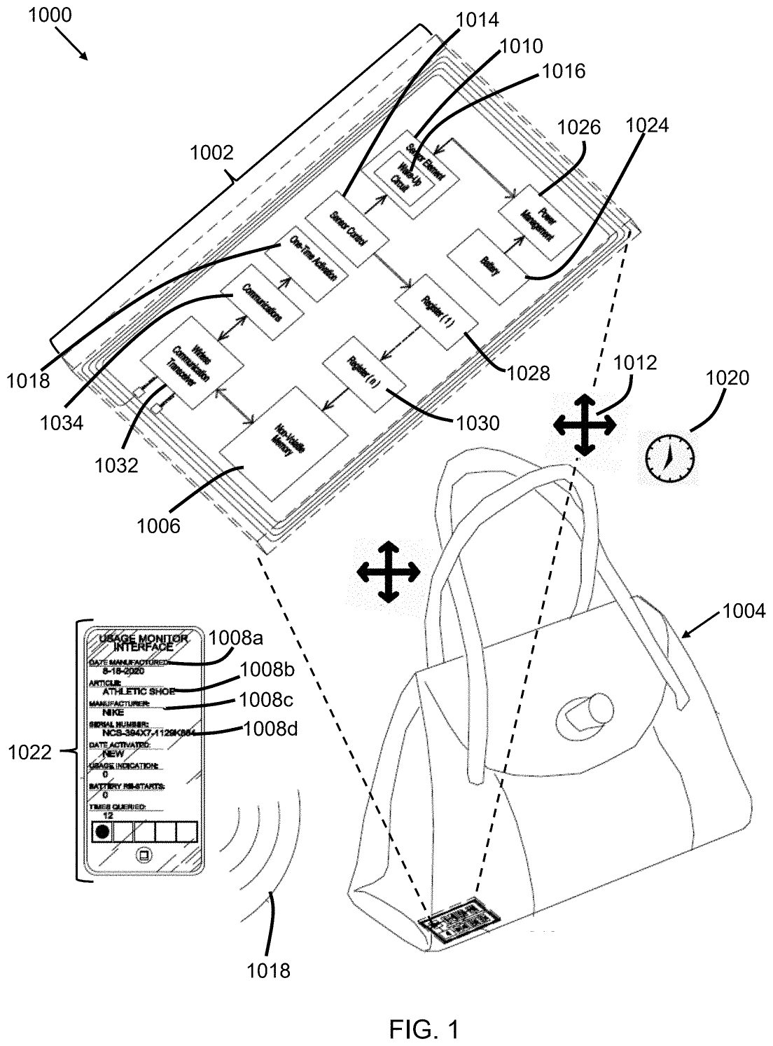

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper,” “lower,” “left,” “rear,” “right,” “front,” “vertical,” “horizontal,” and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Specific dimensions and other physical characteristics relating to the embodiments disclosed herein are therefore not to be considered as limiting, unless the claims expressly state otherwise.

A system 1000 and method 2000 for determining the condition of an article 1004 is referenced in FIGS. 1-15. The system 1000 for determining the condition of an article 1004, hereafter “system 1000” is configured to determine whether an article 1004 is new or used; and if used, how much usage the article 1004 has experienced. Factors, such as article data 1008a-dand motion 1012 by the article are determinative of the new or used state of the article 1004. To identify and record the condition of the article 1004, a smart tag 1002 discreetly integrates into the article 1004.

The smart tag 1002 is an electronic/data component that has integrated therein, article data 1008a-d, which is information pertinent to the article 1004; and which may include an article identity 1008b, a manufacturer 1008c, a serial number 1008d, and a date 1008a the smart tag attaches to the article. The data 1008a-d is indicative of whether the condition of the article 1004 satisfies the at least one predetermined criterion. Also integrated in the smart tag 1002 is a sensor element 1010, operable to detect motion by the article that might indicate a used article. This motion information is logged into the memory of the smart tag 1002, along with other article data 1008a-d.

In essence, the system 1000 is useful for providing a tamper-proof means to determine the article-related data 1008a-d from a smart tag 1002 that is integrated in the article 1004, determine if the article is new or used, and the extent of usage the article 1004 has experienced, or said another way, the life of the article 1004.

Looking now at block diagram FIG. 1, the system 1000 comprises a smart tag 1002. The smart tag 1002 is a small, chip-shaped electrical component that is designed to discreetly fit inside an article 1004, such as apparel, and accessory, a footwear, and a mechanism. An adhesive may also be used to more securely fasten the smart tag 1002 to the article 1004. For example, the smart tag 1002 can fit inside a collar of a shirt, or under the inner sole of a shoe. In one non-limiting embodiment, the smart tag 1002 is hermetically sealed, so as to prevent moisture from entering the electrical elements therein. In some embodiments, the smart tag 1002 includes at least one of the following electrical components known in the art of data storage and processing; especially for attachment to small objects: a wireless communication transmitter 1032, a communications circuit 1034, a micro-controller, a processor, and a firmware program.

In some embodiments, the smart tag 1002 is configured with a unique non-volatile memory 1006 for storing the article data 1008a-d. In one non-limiting embodiment, the non-volatile memory 1006 is a semiconductor memory chip, in which each bit of binary data is stored in a tiny memory cell operatively attached to one or more transistors. In some embodiments, a pair of register circuits 1028, 1030 also serve to store at least part of the article data and/or motion data.

The non-volatile memory 1006 is configured to store data 1008a-d related to the article 1004, including data related to the prior motion by the article 1004 with the smart tag 1002 therein. In some embodiments, the data 1008a-d may include, without limitation, an article identity 1008b, a manufacturer 1008c, a serial number 1008d, and a date 1008a the smart tag attaches to the article. And as discussed above, the article 1004 identity may include, without limitation, an apparel, an accessory, a footwear, and a mechanism. However, any consumer good may also integrate with the smart tag 1002.

Continuing with FIG, 1, the smart tag 1002 comprises a sensor element 1010 that is operatively connected to the non-volatile memory 1006. The sensor element 1010 is configured to sense motion 1012, such as: acceleration, swaying, gravity, impact, and electromagnetic forces. In one non-limiting embodiment, the sensor element 1010 comprises an ultra-low-power high-performance 3-axis accelerometer. The sensor element 1010, being integrated into the smart tag 1002, can detect a motion 1012 of the smart tag 1002. In some examples, the detected motion 1012 can be a shaking motion, a swinging motion, an acceleration, a deceleration, an impactful force, and an escalating motion.

In other embodiments, the sensor element 1010 allows the processor to log usage of the article 1004 if the duration of the motion 1012 exceeds a predetermined duration or intensity parameter 1020. For example, if the smart tag 1002 inside the article 1004 is being shaken for more than 10 seconds, this is logged, so as to indicate a possible used article 1004. Or if the motion is a prolonged swaying motion, this can indicate a used article. However, if the smart tag 1002 inside the article 1004 is dropped for one second, this could simply be a type of motion 1012 that occurs during shipping, so as to indicate the article 1004 is still new. The duration or intensity parameter 1020 can be adjusted to accommodate different articles. For example, for a smart tag 1002 inside a mechanical article 1004, such as a vehicle, can have a longer duration since the vehicle is being driven from the delivery truck to the lot, and then test driven.

In some embodiments, the motion 1012 is categorized in multiple intensities, so as to help determine whether the motion is the type that would indicate a new or used article. Thus, the motion 1012 can be categorized as a density, a sequence, an interval, and an amplitude algorithm of movement. In some embodiments, the density of the motion comprises the intensity of the motion 1012 of the smart tag 1002. In other embodiments, the sequence of the motion comprises a tally of the repetition of motion of the smart tag 1002. In yet other embodiments, the interval of the motion comprises the time between different motions by the smart tag 1002. In yet other embodiments, the amplitude of the motion comprises the strength of the motion 1012 of the smart tag 1002. In one non-limiting embodiment, the smart tag 1002 also includes a sensor control 1014 that is operatively connected to the sensor element 1010. The sensor control 1014 is configured to regulate the sensor element 1010.

The sensor element 1010 includes, integrated therein, a wake-up circuit 1016 that is operable to generate a wake-up signal 1018 upon detection of a query for the data in non-volatile memory 1006. The query can be detected and electromagnetic force, such as an NFC reader, or a laser as is used in other scanning devices known in the art. In this manner, the wake-up circuit 1016 may have an electrical component that is alerted to a scan or a read from a tag reader 1022. The wake-up signal 1018 is operable to enable other electrical components to retrieve the data 1008a-d in the non-volatile memory 1006, in response to the query. Thus, in one embodiment, upon detection of the tag reader 1022 attempting to query the data 1008a-d, the wake-up signal 1018 is generated. Additionally, the wake-up signal 1018 further is operable to enable logging usage of the article 1004 into the non-volatile memory 1006. This logging can include logging the duration of the motion 1012, so as to help determine whether the article is new or used.

The smart tag 1002 also has a one-time-activation circuit 1018 that is operatively connected to the sensor element 1010. The one-time-activation circuit 1018, as the name indicates, is operable to indicate that the article 1004 is new if the duration of the motion 1012 does not exceed the parameter 1020. Further, the one-time-activation circuit 1018 is operable to indicate that the article 1004 is used if the duration of the motion 1012 exceeds the parameter 1020. In some embodiments, if the duration of the motion 1012 exceeds the predetermined parameter 1020, the sensor element 1010 logs usage of the article 1004.

The system 1000 also comprises a tag reader 1022 that is configured to wirelessly communicate with the smart tag 1002; chiefly for the purposes of querying data 1008a-d therefrom. In one non-limiting embodiment, the communication between the smart tag 1002 and the tag reader 1022 is a serial data-stream. In yet other embodiments, the tag reader 1022 is configured to wirelessly exchange the data 1008a-d with the smart tag 1002 through an NFC protocol. Those skilled in the art will recognize that NFC allows for close-range wireless communication therebetween to exchange data. The system is adapted to sense usage once activated. This is accomplished at the ‘point-of-sale’ of an original article (fully authorized by a manufacturer), by the tag reader running a special version of the APPLICATION that allows the activation of the tag. The act of activating the usage monitor (that can never be reset) must be intentional, not an arbitrary ‘movement’ that may be caused by the item being transported or a customer simply reviewing it in consideration to purchase. And once activated, the smart tag can never be reset or deactivated.

As discussed above, the tag reader 1022 serves to initiate the query for the data 1008a-d in the non-volatile memory 1006 of the smart tag 1002. Thus, the tag reader scans the article, and the smart tag 1002 thereby, to find the new or used condition of the article. Additionally, the tag reader 1022 operates to display the queried data 1008a-d from the non-volatile memory 1006. This can be performed through a digital display screen directly on the tag reader 1022, or a remote screen that is in communication with the tag reader 1022. In this manner, the tag reader 1022 can review the article data 1008a-d in order to determine whether the article 1004 is new or used. For example, if the tag reader 1022 scans a manufacturer known to manufacture counterfeit items, the article 1004 may be used (or fake). If the reader scans an article 1004 with a manufacture data 1008a-d of ten years, the article 1004 may be used.

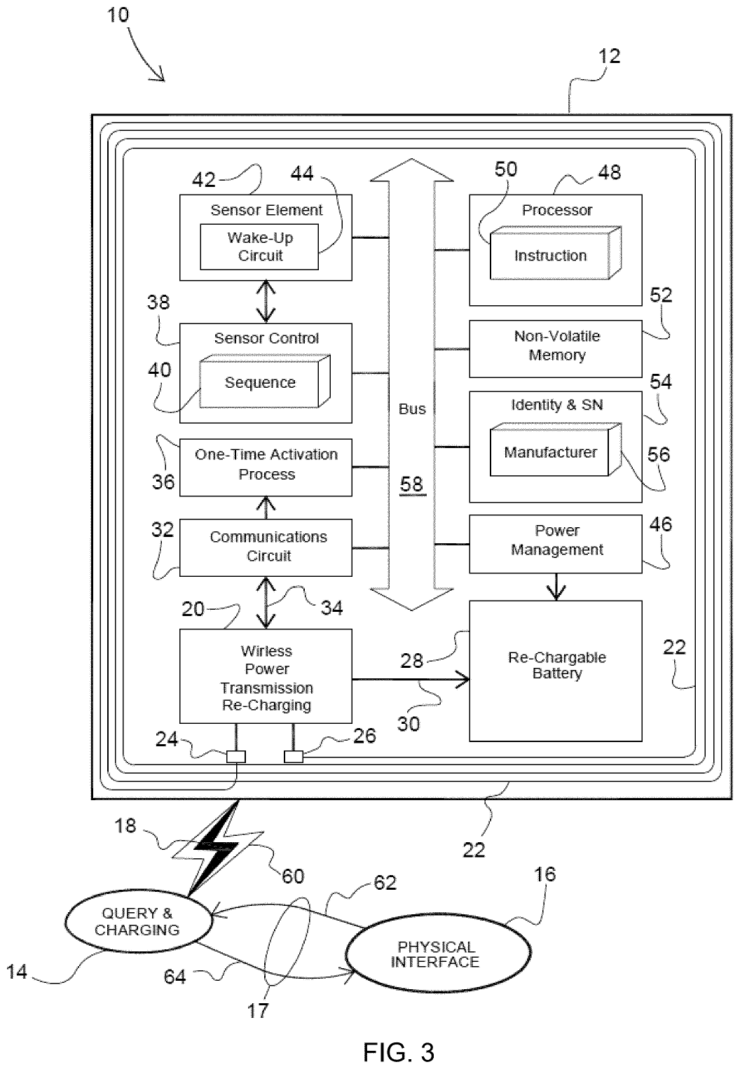

Looking ahead to FIG. 3, the system 1000 further comprises a battery 1024 for powering the smart tag 1002. In some embodiments, the battery 1024 may include a rechargeable battery that can be charged from external power sources, such as a power outlet, a USB wire, or a wireless charger. In other embodiments, the battery 1024 recharges wirelessly using a conventional technique WPT. However, other charging means known in the art may also be used.

In some embodiments, the battery 1024 selectively provides power between a deep-sleep state when the smart tag is not being queried or moving. For example, the battery 1024 is in a deep sleep state if there is no query from the tag reader. This sleeping configuration helps to conserve power. However, the battery 1024 is also adapted to a fully operational state when the smart tag is being queried by the tag reader and/or motion is occurring thereon. While being charged, the smart tag 1002 can be queried for usage information, and requested via the tag reader 1022.

The battery 1024 is operatively connected with a power management circuit 1026 that initiates a deep-sleep state, a wakeup trigger state, and a fully active state. The power management circuit 1026 also serves to monitor the battery 1024. It is significant to note that if the battery 1024 becomes fully depleted, this is an event that is registered and logged in the non-volatile memory 1006. The power management circuit 1026 ensures that the smart tag 1002 is considered as an ‘ultra-low’ power device, only consuming energy as needed, and returning back to deep-sleep state, so as to maximize energy conservation.

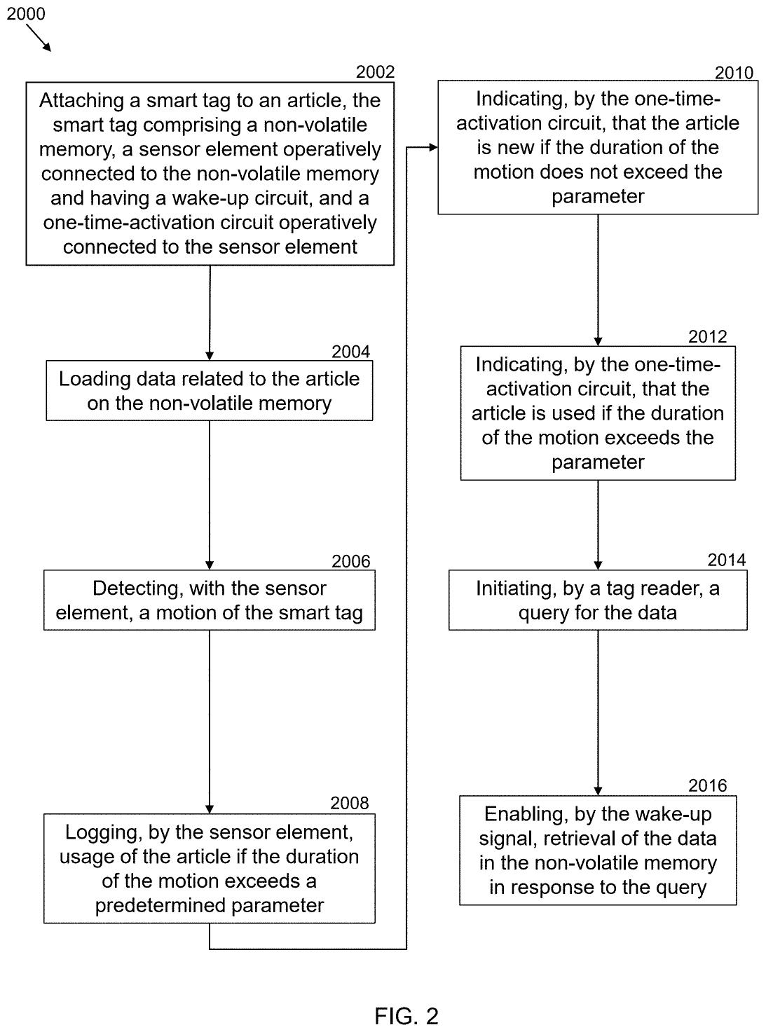

FIG. 2 references a flowchart of an exemplary method 2000 for determining the condition of an article. The method 2000 comprises an initial Step 2002 of attaching a smart tag to an article, the smart tag comprising a non-volatile memory, a sensor element operatively connected to the non-volatile memory and having a wake-up circuit, and a one-time-activation circuit operatively connected to the sensor element. Another Step 2004 comprises loading data related to the article on the non-volatile memory. The data can be loaded during manufacturing of the article. For example, the manufacturer name 1008c and the date of manufacture 1008a. Additionally, the motion 1012 felt by the smart tag is also loaded as data, if necessary.

Yet another Step 2006 may include detecting, with the sensor element, a motion of the smart tag. The sensor element 1010 is configured to detect various types and intensities and durations of the motion 1012. In this manner, it can be ascertained whether the article is new or used. The method 2000 also includes a Step 2008 of logging, by the sensor element, usage of the article if the duration of the motion exceeds a predetermined duration or intensity parameter. Another Step 2010 comprises indicating, by the one-time-activation circuit, that the article is new if the duration of the motion does not exceed the duration or intensity parameter.

Yet another Step 2012 may include indicating, by the one-time-activation circuit, that the article is used if the duration of the motion exceeds the duration or intensity parameter. For example, if the duration of the motion is recorded as more than 10 seconds, and the intensity is unnatural for that type of article, it may be deduced that the article is used. The method 2000 also includes a Step 2014 of initiating, by a tag reader, a query for the data. A final Step 2016 comprises enabling, by the wake-up signal, retrieval of the data in the non-volatile memory in response to the query. Once the data is collected, the new or used condition of the article can be determined.

Additional embodiments of the system 1000 are also possible, as referenced in FIG. 3. As illustrated, the system can include a self-contained hermetically sealed electronic micro-controller for a smart tag 10. The smart tag 100, in this case is inside an encapsulated housing 12. The encapsulated housing 12 fully contains the components of the usage monitoring device and is ready to be embedded in any intended article during manufacturing. The block diagram of FIG. 1 is an exemplary system for a self-contained hermetically sealed electronic micro-controller for a smart tag, in accordance with some embodiments of the present disclosure, having a query and charging 14, a tag reader 16, a wireless power transmission 20 (WPT), and a near field communications 60. In operation, the tag reader 10 can re-charge its battery (as will be disclosed later) wirelessly using a conventional technique as known as WPT; wireless power transmission and referenced as the solid bold line in WPT 18. While being charged, the tag reader 10 can be queried for usage information, and requested via the tag reader 16. This communication is accomplished by a near field communications 60, as referenced in the light lines. One means of near field communications 60 is carrier communications and uses a number of schemes; including frequency shift modulation, or, amplitude shift modulation among others. This very short range ‘Near Field Communication’ (NFC) technique is shown as an example in FIG. 1, other figures may show a Bluetooth or the alike, slightly longer-range communication device is also appropriate.

Within the self-contained hermetically sealed electronic micro-controller for a smart tag 10 is, a wireless power transmission re-charging 20 component, a coil 22, a coil first end 24, a coil second end 26, a re-chargeable battery 28, and a communications circuit 32. When the smart tag (and being embedded in a manufactured article as will be discussed later) is placed on a re-charging station (which also will be discussed later) for this purpose, the wireless power transmission re-charging 20 component interact via the WPT coil 22; providing a power source of current (as indicated in the WPT 18 wirelessly, to recharge the re-chargeable battery 28 as referenced in arrow 30. Additionally, should a query request, from a tag reader 16 be initiated (via the tag reader exchange 17), a carrier signal (as referenced in the communications 60 lines) further transmit data to and from the communications circuit 32 and the tag reader 16 as referenced via lines request 62 arrow and response 64 arrow respectively. The reference arrow 34 help facilitate the data to and from the internal processing within the smart tag. More on these subjects will be discussed later.

Continuing in the FIG. 3 block diagram is a one-time-activation process 36. The one-time-activation process 36, is a single, one-time execution of the enabling of the smart tag. This process is not repeatable or resettable. Once activated, the smart tag status changes from ‘NEW’ to ‘USED’ and can never go back. The actual process to execute the one-time-activation process 36, is detailed later in the disclosure.

Further in FIG. 3 block diagram is shown a sensor control 38, a sequence 40 process, a sensor element 42, and a wake-up circuit 44. The smart tag 10 is always in a deep-sleep state (to conserve power) until the wake-up circuit 44 triggers the system to come alive. The sensor element 42, controlled via sensor control 38, then determines if a full wakeup of the system is appropriate. In a case where the article was just ‘bumped’ for example (as in a jacket simply being moved when another object was retrieved from a closet), the subject article's tag reader 10 would then go back to deep-sleep. In the case where the sensor element 42 sees continued sensor activity, the smart tag 10 would become fully operative, and begin the sequence 40 process and determine the dynamic representation of usage.

A power management 46 process works in concert with the above deep-sleep, wakeup triggering, and fully active states mentioned earlier. The power management 46 also serves to monitor the rechargeable battery 28, and, should the battery ever fully become depleted, will register such event and be logged in non-volatile memory (that will be discussed in the next section). The power management 46 process maintains that the smart tag is considered as an ‘ultra-low’ power device, only consuming energy to the extent as needed and always returning back to deep-sleep in an effort to reserve as much energy as possible. It should be explicitly understood, that the waking up is the determination that an actual need to bring alive the system is in fact required, else would stay in a deep-sleep state. This will be more apparent as the following figures are disclosed.

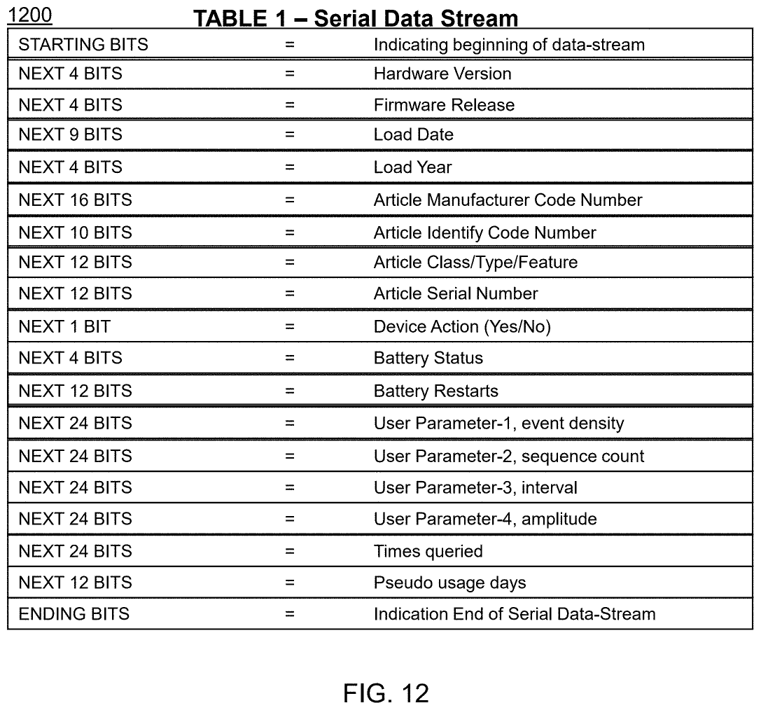

A processor 48, an instruction 50 set (firmware), a non-volatile memory 52, an identity and serial number 54 register, a manufacturer 56 register, and a bus 58 are also shown in FIG. 1. The Processor 48 and the firmware instruction 50 are the operating system of the tag reader 10 and function the device as described. It is important to understand that the information loaded into the identity (article type, class, etc.) and serial number 54 and manufacturer 56 can never be changed once it is loaded at time of the device (article that the smart tag 10) is being manufactured. A full discussion on this process is disclosed in FIG. 12. The non-volatile memory 52 stores the logged usage data and can only function as an addition to usage totals (never a subtraction in an accumulation of usage). The various components within the smart tag 10 system, may communicate with each other via one or more busses, as referenced as the bus 58.

In review of FIG. 3 1, the importance of the wake-up circuit 44 has two significant functions. Firstly, it affords the apparatus to go to a deep-sleep state conserving power (being the smart tag may see very long periods of non-use, as in a jacket hanging in a closet). And second, after the wake-up circuit does the waking up of the apparatus, it can further be an additional sensing means to determine the accumulative usage in the monitoring and logging usage events of the article that it is embedded/installed into. A suitable wake-up device would be one manufactured by OncQue as part number RBS100610T, a contact ball sensor (rolling ball) for example. Other sensors in the sensor element 42 circuits may be a ultra-low-power high-performance 3-axis “femto” accelerometer manufactured by ST Life.Augmented as LIS2DE12 as another example.

One further important aspect to understand in the wake-up circuit 44, is that a single triggering of the (either and closing or opening of a switch) sensor, such as the example of the rolling ball above, would not constitute a full wake-up. A wake-up must see multiple triggers of the sensor, over a duration of time, for example five or ten seconds, in which the smart tag is embedded. The issue of bring the apparatus to full active state, and needlessly consuming energy is solved; by delaying in effect, the process of waking up unnecessarily, as in the case of the article just being bumped.

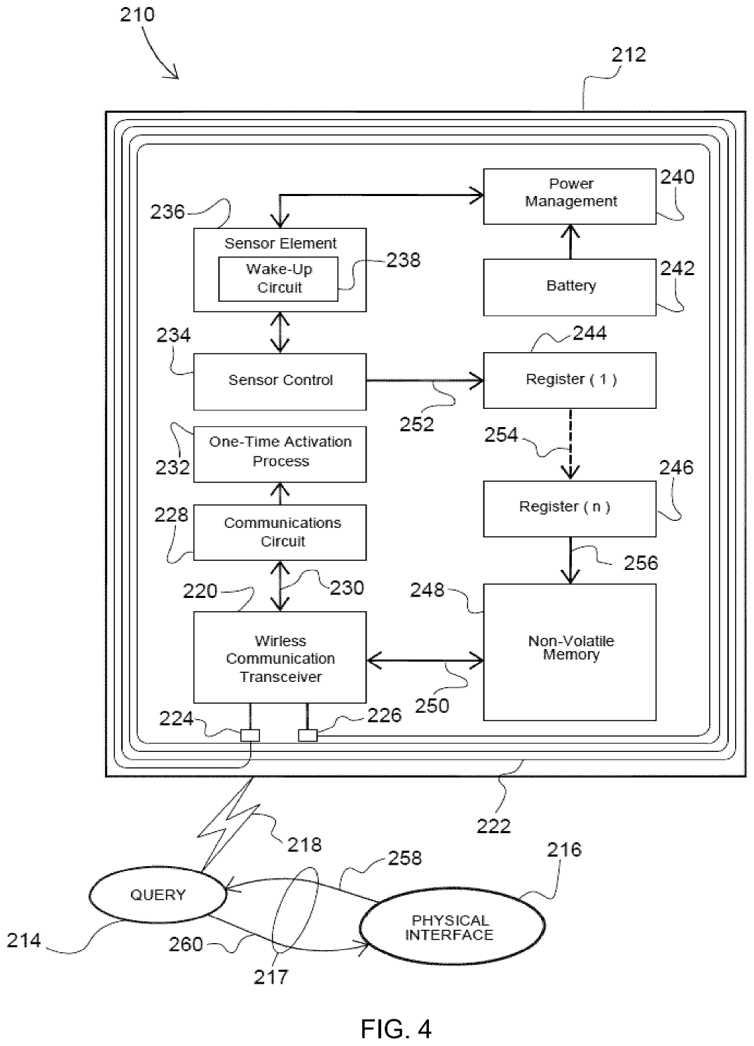

Turning now to FIG. 4, an alternate configuration of a smart tag 210, to more fully appreciate the present invention in its scope of applications. In this configuration, we see much of the functionality present in FIG. 1 (and therefore will not repeat detail of the references in the block diagram), but no battery recharging capability, and therefore is considered to have limited life application. And thus, be manufactured as a cheaper device meant for lower priced goods; that do not have long life. Here we see a simplified operation (note the processor is not shown) to make usage monitoring as easy as possible to implement and understand. The register (1) 244 and register (n) 246 represent the simplified logging of usage events; before being stored as an accumulation of usage in the non-volatile memory 248. The communications 218 and wireless communication transceiver 220 reflect only a minimal means to query and retrieve usage data (as will be more fully disclosed later).

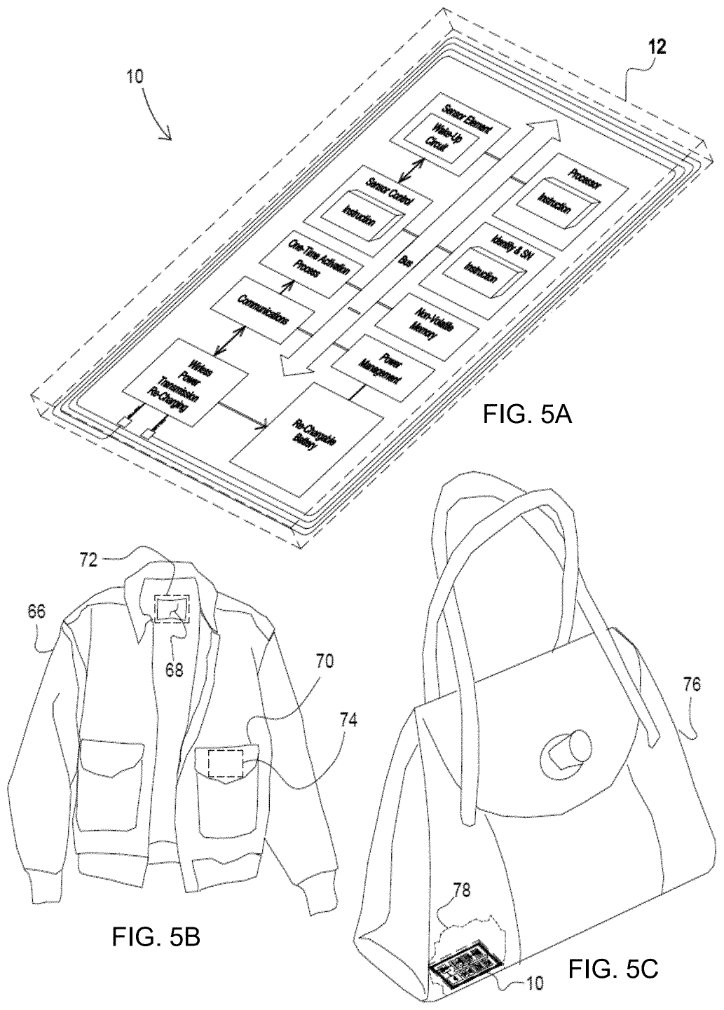

FIG. 5a shows the self-contained hermetically sealed electronic micro-controller for smart tag 10, with the encapsulated housing 12 having some dimension to it for illustration. This is to emphasize that the apparatus when assembled can easily fit in articles of almost any size in an unobtrusive way. Physically the size, when miniaturized, could be as small as a few postage stamps (even smaller with extensive use of application specific integrated circuit (ASIC) chips using both analog and digital signal processing). It is important to understand that the encapsulated housing can be fashioned to fit the function, for which it is intended to be embedded in as a finished manufactured article.

FIG. 5b illustrates the smart tag 10 of FIG. 5a, being manufactured into an apparel article example 66, shown here as a leather jacket, in accordance with some embodiments of the present disclosure. The apparel article example further depicts two examples of placements of the smart tag 10; first behind the garment label 68, shown as dashed line 72, and, within pocket flap 70, shown as dashed line 74. The locations, as depicted in dashed lines 72 or 74 are just examples, and that the smart tag 10 could be manufactured into any location of an apparel article.

FIG. 5c illustrates the smart tag 10 of FIG. 5a, being manufactured into an accessory article example 76, shown here as a lady's purse, in accordance with some embodiments of the present disclosure. In the accessory article example 76 shows the placement of the smart tag 10 being in the bottom/corner of the subject lady's purse as shown within cutaway 78 dashed line. Again, the location is just an example and the smart tag could be located and manufactured into any location of an accessory article.

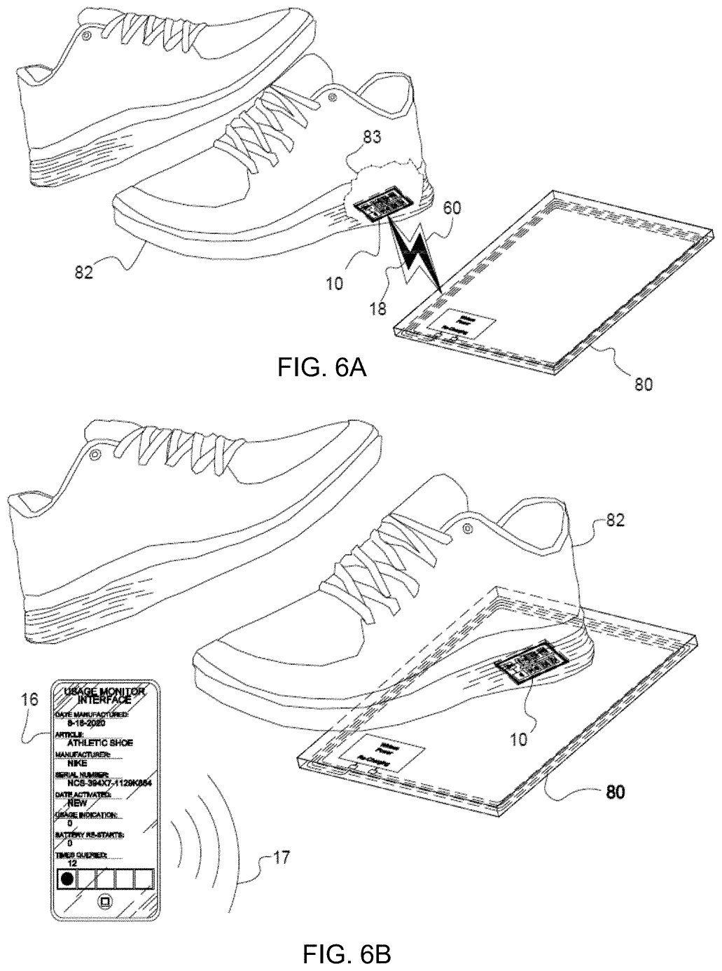

Turning to FIG. 6a, illustrates the smart tag 10 of FIG. 5a, being manufactured into a footwear article example 82, shown here as an athletic shoe, in accordance with some embodiments of the present disclosure. In the footwear article example 82 shows the placement of the smart tag 10 being in the bottom/back of the sole as shown within cutaway 83 dashed line. Again, the location is just an example and the smart tag could be located and manufactured into any location of a footwear article. Please note that a smart tag need only be in one of the paired shoes, being that in use, certainly both shoes would experience the same usage, and therefore only one shoe (in a pair) would need monitoring.

Further in FIG. 6a, is illustrated a charging station 80. Illustrated is the very short range ‘Near Field Communication’ (NFC) technique between the smart tag 10 and the charging station 80; whereby wireless power transmission 18 and the carrier communications 60 illustrate both the re-charging of the rechargeable battery 28 and communicating with the communications circuit 32, as referenced in FIG. 1. The charging station can be powered by battery or connected to an AC Voltage source, or both (not shown). Both the wireless power transmission 18 recharging and the near field communications 60 will be more fully disclosed later.

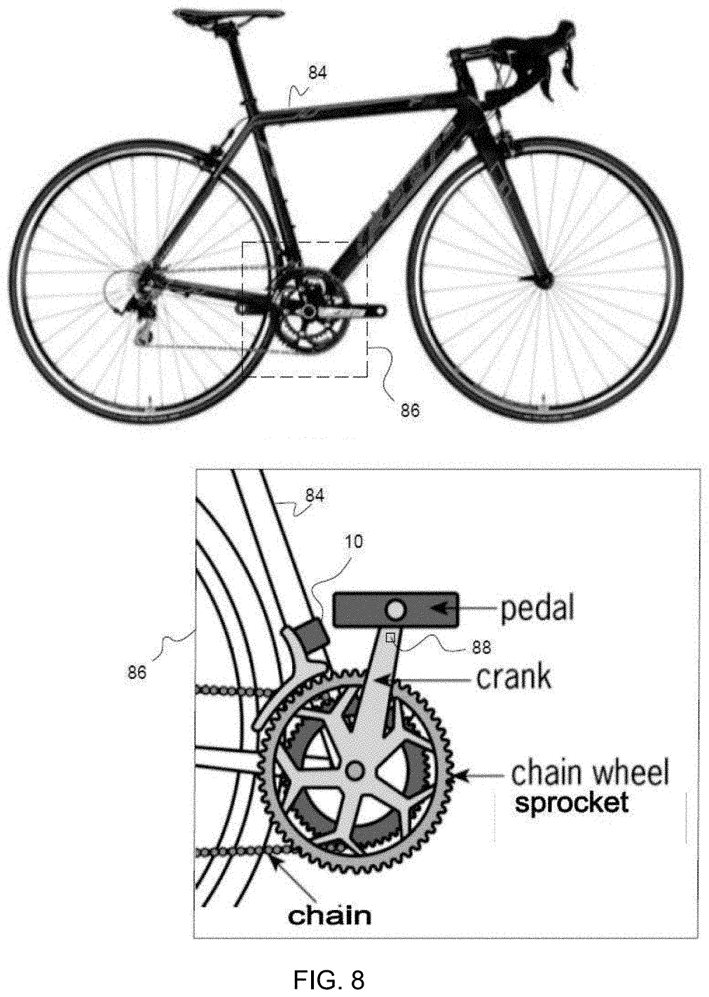

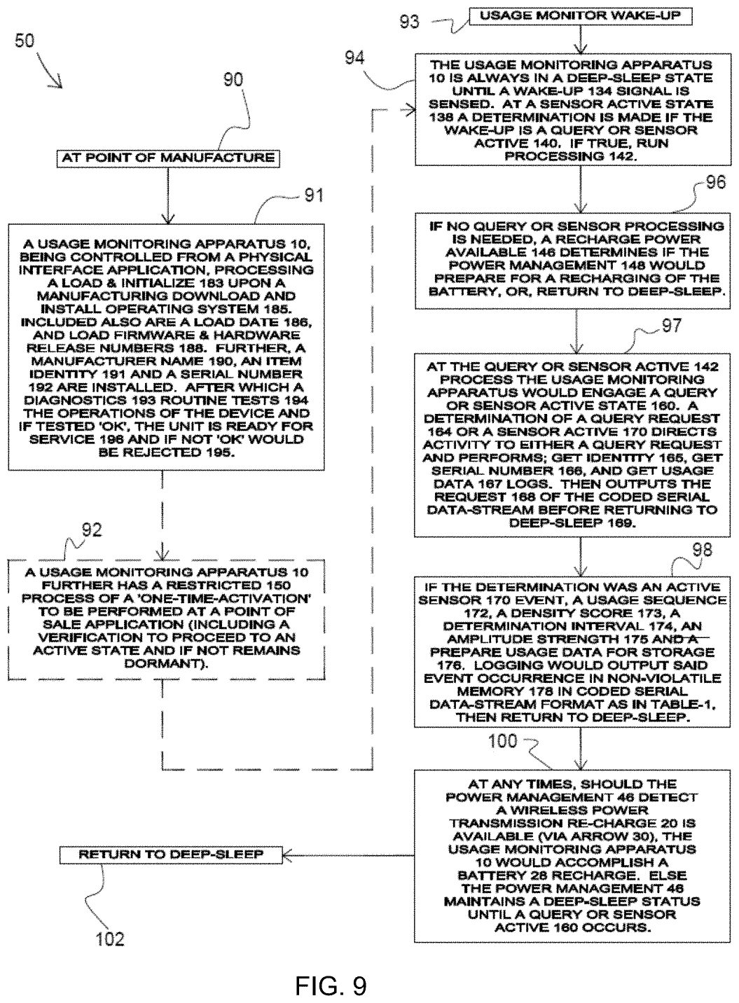

The FIG. 6b shows the setup of FIG. 6a, with the footwear article example 82 sitting atop the charging station 80, and, the tag reader 16 communicating a query 14 via the tag reader exchange 17, with the charging station and the smart tag 10, as referenced in FIGS. 1 and 4a. The display on the tag reader 16, showing the queried information result, will be further detailed in FIGS. 8 and 9, disclosed later.

In FIG. 6b, the tag reader 16 is illustrated as a conventional cellphone. The cellphone is ideally suited, because it has communications and Internet capabilities already built in; as well as the fact that nearly everyone has a cellphone. The cellphone additionally has sufficient computing power to operate an application (APP), suited to unpack (decode) the queried data-stream from the smart tag, and if needed via the Internet, compare said data with the article's manufacturer network server to validate the article's authenticity. Throughout this disclosure, the cellphone will be indicated as the tag reader, but, it is important to understand, that any computing device, either conventional or specifically designed to function to interface with the tag reader 10 and retrieve and decode and display the data-stream, would be appropriate.

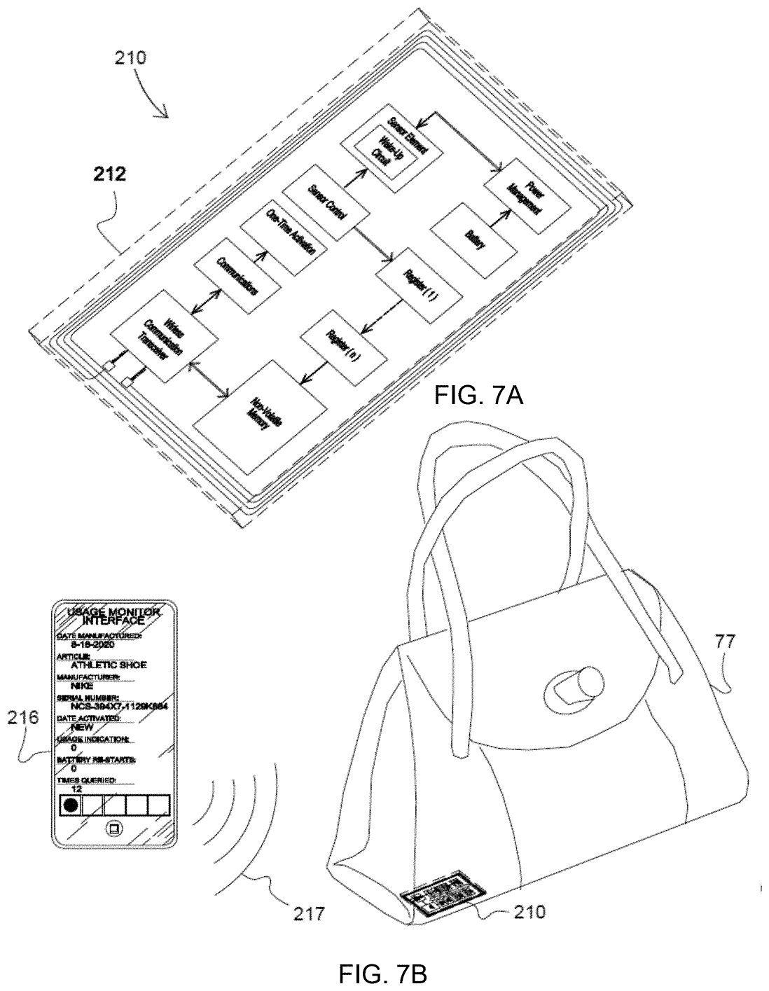

Moving on to FIG. 7a, is an isometric view of a self-contained hermetically sealed electronic micro-controller for an alternate embodiment of the smart tag 210, that is encapsulated with components as described in the alternate block diagram of FIG. 4; in accordance with embodiments of the subject matter described herein. In FIG. 7b illustrates the alternate smart tag 210 of FIG. 7a, being manufactured into an accessory article alternate example 77 item, and, showing the alternate tag reader 216 communicating via the alternate tag reader exchange 217. It should be apparent that communications (among other features) between FIGS. 3, 5 and 6a-6b are different than communications in FIGS. 4 and 7a-7b. whereby, the first uses a Near Field Communication technique, via the charging station 80 to connect to the smart tag 10, and the second, uses a direct communications (such as Bluetooth) technique to communicate to the alternate smart tag 210. More will be disclosed later on the benefits of these two communication techniques.

One further important feature, in the alternate embodiment of the smart tag 210, is that this system is non-rechargeable, and therefore has a single life to its battery. In such a configuration, it would be possible to have a battery ‘start-operations’ procedure. One example of a start-operations procedure would be to have a ‘ribbon’, that isolates the battery contacts, that was installed at time on fabricating the smart tag, and, the article it is embedded in. Such ribbon would be accessible, and would be ‘pulled’ out of the device at time of sale; making continuity of the battery contacts with the smart tag 10 circuitry, and now the apparatus functionable and ready to operate as discussed above for the duration of its life.

It should be obvious, that combining features of those indicated in FIGS. 3-4 can be facilitated to achieve further functionality to the extent that they are combined. And further, a replaceable battery could be constructed into the smart tag, instead of the one-time non-rechargeable battery depicted in FIG. 4. In such a configured device, the accounting of battery depletion would be registered as events experienced and be part of the permanent data stored in the non-volatile memory (battery depletion events will be discussed in more detail later).

FIG. 8 is an illustration showing the smart tag 10 of FIG. 3a, being manufactured into a mechanized article example 84 item; here being represented as a bicycle. The detail box 86, shows an example wherein, the tag reader 10 is placed on the frame of the bicycle in the vicinity of the front chain wheel crank and sprocket. In this example, of the sensor type use within the smart tag 10, is a proximity technique. Wherein a magnet 88, disposed on the crank near the pedal, is in direct path of the proximity sensor (within the encapsulated smart tag 10) and when the magnet field crosses the proximity sensor, registers a usage pattern representing that the bicycle is physically being operated. A proximity sensor is typically a ‘reed-switch’ whose activation is either OPENED or CLOSED with the magnet flux is within its space. A suitable proximity technique would be a reed switch, such as manufactured by Srandex Electronics in one of their SW or KSK-GP560 Series Reed Switches.

It is important to understand that this is an example placement of, and a sensor type of the smart tag 10. Other locations, such as the front or rear frame locations could monitor the rotation of the wheels, or, on the handle braking system to monitor when brakes are being applied. All these and other locations and sensor types (such as an accelerometer mention above) could also represent a usage detection of the mechanized article example 84, in accordance with some embodiments of the present disclosure.

FIG. 9 is a flow chart diagram showing the operational process of the present invention of the smart tag 10, in accordance with an embodiment of the present disclosure. The instruction set 50 (as referenced in FIG. 3) is revealed in a logical order. Wherein AT POINT OF MANUFACTURE ROUTINE 90 starts a LOAD and INITIALIZE ROUTINE 91. In this routine all pertinent information is downloaded and the unit is tested. As a matter of practicableness, this function would be done at the smart tag fabrication facility as an order for the devices from an article manufacturer, for example 10,000 units. Then the 10,000 units would be downloaded with said article manufacturer's name and the item information (sequential serial number, etc.) and delivered to the article manufacturer. At time that the article is being fabricated, the article manufacturer then would only have to embed/install the (already programmed) smart tag into their article and scan it for a query to reveal the correctness of the serial number before said information going into their data-base. It is in this manner, that the smart tag 10 becomes an original equipment manufacturer (OEM) supplier to article manufactures of apparel items, accessory items, footwear items, and mechanized items with great efficiency.

A RESTRICTED PROCESS ‘ONE TIME ACTIVATION’ ROUTINE 92, shown in dashed lines to distinguish the importance of the function; to activate the smart tag. This process is intended to be operated at the point of sale of the article, and, once activated can never return to an inactive state. That is, the article (with the unit embedded into it) is no longer ‘NEW’ but ‘USED’, and the smart tag shall henceforth sense and log all usage activity it its non-volatile memory for uploading at queries to a tag reader for display on demand.

At this instants, the USAGE MONITOR WAKE-UP ROUTINE 93 is in general use and when a wake-up event occurs, the DETERMINE IF ACTIVE SENSOR ROUTINE 94 is real (not just being bumped) and if so advances as a usage event, else would PREPARE FOR RECHARGING ROUTINE 96 or return to deep-sleep.

When advanced to a QUERY OR SENSOR ACTIVE EQUALS QUERY ROUTINE 97, and the determination is a query request, a process to get stored and logged information is performed to fulfill the request; and an upload is achieved with the serial data-stream to a tag reader making the query.

If the QUERY OR ACTIVE SENSOR EQUALS ACTIVE SENSOR ROUTINE 98, the wake-up is a real usage event, and the smart tag 10 then does the process of logging said usage as is appropriate. Please see TABLE-1 Serial Data-Stream for usage parameters; 1-event density, 2-sequence count, 3-interval, and 4-amplitude. These parameters will be more fully discussed later in the disclosure.

The POWER MANAGEMENT ROUTINE 100 once again is central to long battery life to the smart tag 10, in that it always performs a check to see if a RETURN TO DEEP-SLEEP ROUTINE 100 can minimize power consumption, or look for a wireless power transmission (WPT) recharge of the battery.

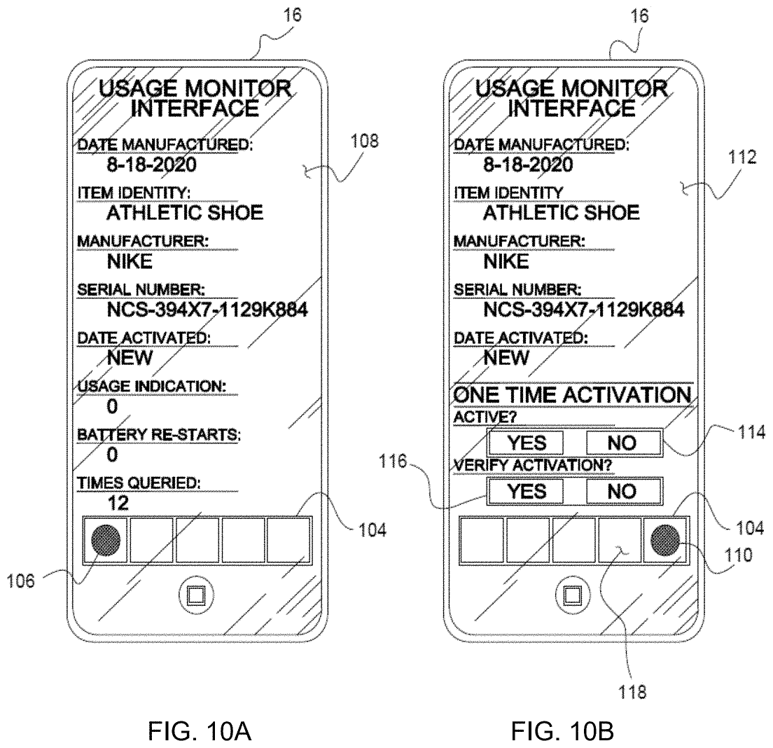

Turning now to FIG. 10a, where an example of the tag reader 16, running an application and displaying a representation of a usage screen showing logged data obtained from the smart tag 10 of FIG. 6b, in accordance with an embodiment of the present disclosure. Within the application (APP) an APP display selection array 104, have function buttons that are used to access various screens. A usage selection button 106, invokes a display usage screen 108, wherein are pertinent information relating to the article being monitored for usage. In the example of FIG. 10a, the usage monitor interface screen shows: DATE MANUFACTURED, ITEM IDENTITY, MANUFACTURER NAME, SERIAL NUMBER, DATE ACTIVATED USAGE INDICATION BATTERY RE-STARTS and TIMES QUERIED.

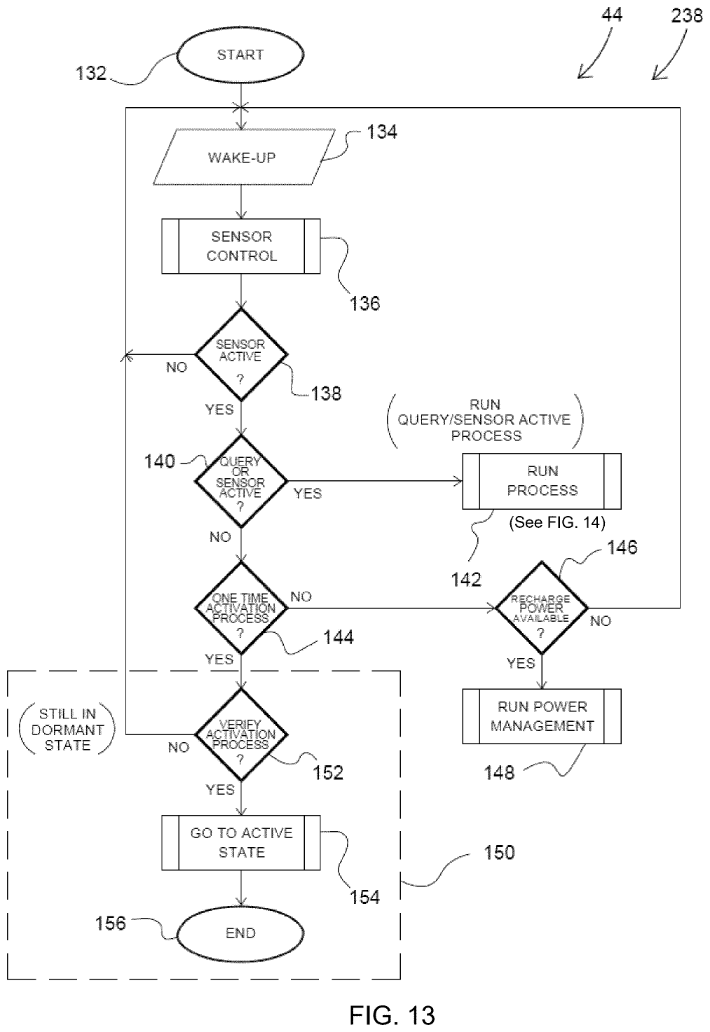

FIG. 10b shows an example of the tag reader 16, running an application and displaying a representation of a usage screen showing ONE-TIME-ACTIVATION means for the smart tag 10 of FIG. 1 as reference 36, in accordance with an embodiment of the present disclosure. Within the application (APP) an APP display selection array 104 indicating the function button activation selection button 110 being accessed. The activation selection button 110, invokes a display usage screen 112, wherein are relevant information relating to the article being monitored, and, the activate ‘YES/NO’ button 114 and verify activation ‘YES/NO’ button 116. The use and need of these selections will be detailed in FIG. 13.

Further, in FIG. 10b, and on the APP display selection array 104, is a manufacturer's selection only button 118. This selection is an example of how a manufacturer of a subject article would ‘download’ it's product information (manufacturer name, product identity and serial number, etc.) and initialize the smart tag. The function of this button 118 will be detailed and fully disclosed in FIG. 12.

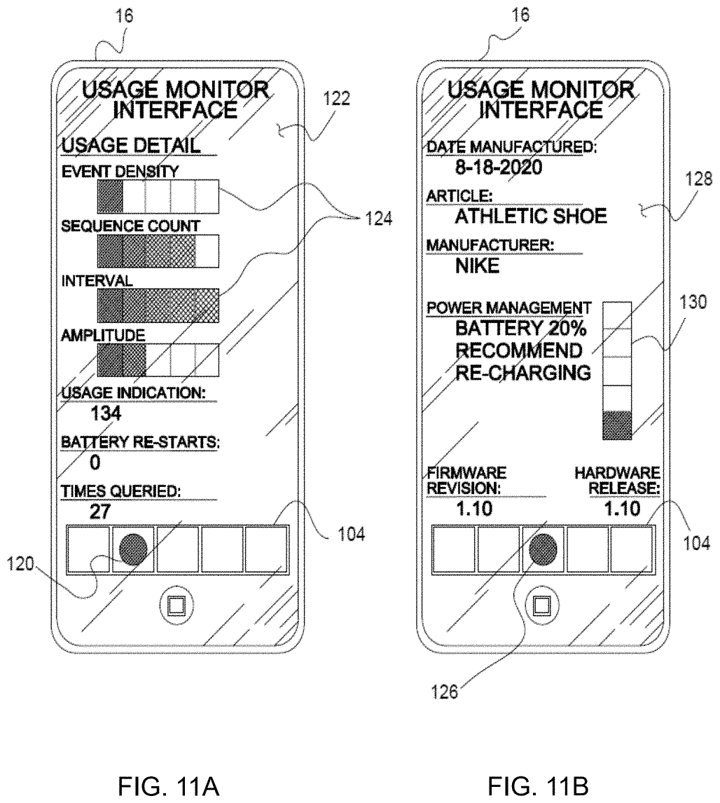

In FIG. 11a, shows an example of the tag reader 16, running an application and displaying a representation of a usage screen showing a detail of data obtained from the smart tag 10 of FIG. 4b, in accordance with an embodiment of the present disclosure. Within the application (APP) an APP display selection array 104 indicating the function button usage detail selection button 120 being accessed. The usage detail selection button 120, invokes a display usage detail screen 122, wherein are relevant information relating to the article being monitored, and, a usage indicators 124. Each of the usage indicators 124 are representations of various sequencing and accounting of data retrieve during usage of the apparatus being monitored. An EVENT DENSITY, a SEQUENCE COUNT, an INTERVAL, an AMPLITUDE are all indicators of the logged usage, and is given a score as a USAGE INDICATION (this could be interpreted as pseudo days of use as a dynamic representation of the usage). Think of the usage indications as being similar to the odometer reading in an automobile as an indicator of usage, and therefore a gauge of wear-and-tear.

FIG. 11b shows an example of the tag reader 16, running an application and displaying a representation of a usage screen showing a viewing of power management detail, data obtained from the smart tag 10 of FIG. 3, in accordance with an embodiment of the present disclosure. Within the application (APP) an APP display selection array 104 indicating the function for a power management selection button 126 being accessed. The power management selection button 126, invokes a display power management screen 128, wherein are relevant information relating to the article being monitored, and, the specific current status of the battery power indicator 130, along with power management recommendations. This screen also is shown the FIRMWARE REVISION of the current operating system and HARDWARE RELEASE of the subject smart tag.

Within all these screens referenced in FIGS. 10a, 10b, 11a and 11b show the usefulness of an APP, functioning on a tag reader 16 device, that queries and retrieves usage monitoring data from an article being monitored for usage. Although these many screens show a great deal of information being accessed and displayed, the data itself is a simple serial data-stream, that is coded and stored in the non-volatile memory 52 or 248 (of FIGS. 1 and 2 respectively) and communicated as the result of a query 14 and tag reader exchange 17 of data (or 214 and 217).

As FIG. 12 references, an example of the coded serial data-stream is in Table 1 1200, and its decoding. Table 1 1200, is just under 200 bits, including the starting and ending bit sequences. It is important to understand, that with an ultra-low power device, such as the smart tag 10, it needs to be efficient as possible to not only operate and store the monitored data, but in its means to transfer said data from the apparatus to a tag reader for display. In the above figures and table, the serialized data stream is a single burst of coded data released only once (in any particular query event) when requested and then goes back to deep sleep; so as not to waist precious battery power. All of the data manipulation is accomplished in the tag reader 16 application, wherein there is abundant memory and functionality to ‘un-pack’ and decode the data-stream and display the acquired usage detail to many useful purposes.

It should be noted that the first two bit field categorizations are the hardware version and firmware release, so the tag reader can always know how to unpack the remaining serial data-stream. This affords that future releases and legacy releases will never become obsolete.

To fully appreciate the coded aspects of the coded data, an explanation of one of the coded bits is offered. For example, the 16 bits of the ‘Article Manufacturer Code Number’ represents some 65,536 possible manufacturers (e.g. 2 to the 16^{th}). Each of the sixty five thousand manufacturers would have an 10-bit ‘Article Identify Code Number’ equaling 1,024 possible items in their repertory of items. It is in this manner that the coded data-stream can efficiently support a very large scheme of data in a very small packet. That is, all the information is part of the application running on the tag reader (either as a stand-alone or with the Internet/Cloud), and the application would compare the coded correlative (in the data-stream) to the corresponding field in the APP. An example of this could be for the 9 Bits=Load Date, in that the permutations of the nine bits equals 512 possibilities, and, the correlative value of (1) would be January 1^{st,} and a value of (365) would be December 31^{st} . (note that the year has its own correlative in the example Table-1).

One other important detail in the data-stream structure are the usage parameters; 1—event density score, 2—sequence count, 3—interval, and 4—amplitude. Unlike any prior art, which simply counts steps taken for example in an athletic shoe, the present invention has ‘depth’ in determining the extent of the steps; are they just walking? Is there a more rigorous activity happening such as jogging or a fast run? Even more distinguishing a hard terrain would produce another signal signature. It is by the usage parameters; 1-event density (to score the intensity of sensed signals, in the gauging the degree of usage), 2-sequence count (to tally the repetition of sensor activity, in monitoring the recurrence of usage), 3-interval (to grade the time between signals, measure the gap-period), and 4-amplitude (to ascertain strength of a sensed signal, and scale any particular usage event), to produce a ‘signature’ of the activity and log a dynamic representation of the usage being monitored...a true measurement achieved by the smart tag 10.

Please note that in the Table1 1200 example, each of these parameters are a 24-bit value, a very large possible number; to take an accumulative logging of such parameters over the life of the article and apparatus. Think of these parameter fields as buckets, that are filled as usage happens, and each time there is another usage the bucket gets fuller (they can only be added to, never subtracted from).

One further point to explain in the Table 1 1200 example, the Pseudo Usage/Days correlative field. In some embodiments, a pseudo clock representing days of operation could be incorporated. Such pseudo clock in the example of the 12 Bits=Pseudo Usage/Days (in the Table-1) the permutations would have a life of 4,024 days or 11.2 years of life before the correlative is full. More on the data-stream will be discussed later in this disclosure.

FIG. 13 is a flow diagram showing the process of a WAKE-UP routine of the self-contained hermetically sealed electronic micro-controller for a smart tag 10 (as indicated if FIGS. 1 and 2 as wake-up circuit 44 and alternate embodiment wake-up circuit 238 respectively) , and, the ONE-TIME-ACTIVATION routine, in accordance with an embodiment of the present disclosure. A START 132 begins the process as wake-up sensor detects. A WAKE-UP ACTION 134, a SENSOR CONTROL 136 and a SENSOR ACTIVE-? 138 process is effected. The SENSOR ACTIVE 138 ‘NO’ response would cause the process to return back to the beginning in the case of not sensed as being used. The smart tag being not used (the WAKE-UP ACTION 134 is a true sensed physical action of usage, not just simply that the article was being bumped, as an example) and would go back to deep-sleep.

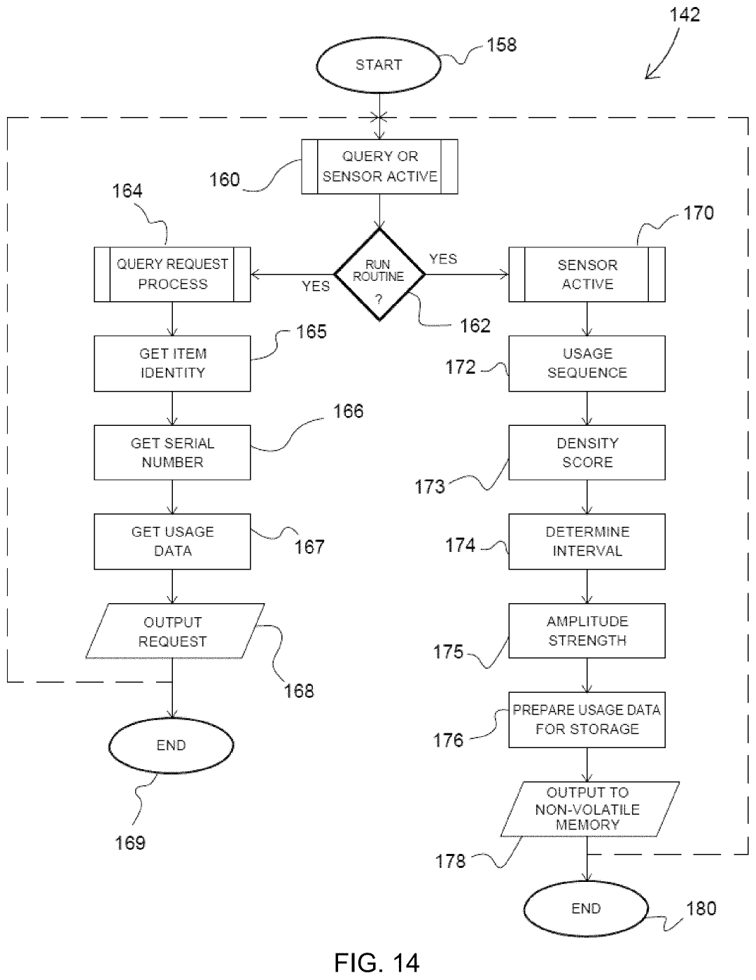

In the case of a true usage sensed, SENSOR ACTIVE 138 would advance to a QUERY OR SENSOR ACTIVE-? 140. If true, the RUN QUERY/SENSOR PROCESS 142 is entered (reference 142 is detailed in FIG. 14), else a ‘NO’, not true would advance to ONE-TIME-ACTIVATION process-? 144. A ‘NO’, not true would question if RECHARGE POWER AVAILABLE-? 146 is possible. If a ‘NO’, not true is the result, the routine reverts back to the beginning to re-evaluate the wake-up or return back to deep-sleep. If the RECHARGE POWER AVAILABLE-? 146 is true, then the RUN POWER MANAGEMENT PROCESS 148 is entered; whereby the re-chargeable battery 28 is charged via the wireless power transmission re-charging 20, as referenced in FIG. 3. Or, as is in the case in FIG. 4, the power management would send the apparatus 210 back to deep-sleep.

The ONE-TIME-ACTIVATION process-? 144 if ‘YES’, the true advance would require the restricted process 150 to be functioned on a ‘Point-of-Sale’ accessible application running on the tag reader 16. If said restricted process 150 is allowed (and referenced in FIG. 8b as the activate ‘YES/NO’ buttons 114 and the verify activation ‘YES/NO’ buttons 118), the VERIFY ACTIVATION PROCESS 152-? is questioned. If ‘NO’ not true, the process reverts back to the beginning of the routine to re-evaluate the wake-up or return back to deep-sleep, and, the smart tag remains in a dormant state, i.e., a ‘NEW’ article, that was never used. Else if ‘YES’, the true path advances to the GO TO ACTIVE STATE 154 and the process end 156 completes the routine.

If the system entered the GO TO ACTIVE STATE 154, the smart tag is now in the usage collections state and is considered ‘USED’, no longer new. The question now is . . . “to what extent of usage is the apparatus and the article it is embedded in, used.” Here forward, the amount of accumulated usage data will determine the amount of usage that the smart tag 10 has experienced. It is important to understand, that once the GO TO ACTIVE STATE 154 is processed, the routine can never go back to an inactive (new state), i.e., the unit is now used. It is because of this importance, that there is the restricted process 150, that can only be accomplished on a point-of-sale version of the tag reader 16.

FIG. 14 is a flow diagram showing a RUN QUERY and SENSOR ACTIVE routines 142 (as referenced in FIG. 10), of the self-contained hermetically sealed electronic micro-controller for a smart tag 10, in accordance with an embodiment of the present disclosure. The routine START 158 and enters a QUERY OR SENSOR ACTIVE PROCESS 160. A determination is accomplished at RUN ROUTINE-? 162; to go to a QUERY REQUEST PROCESS 164, or, to a SENSOR ACTIVE PROCESS 170. The QUERY REQUEST PROCESS 164, leads to a GET ITEM IDENTITY 165, a GET SERIAL NUMBER 166, and a GET USAGE DATA 167. This info/data is then outputted at an OUTPUT REQUEST 168 (in the coded serial data-stream form earlier mentioned and in the example of Table-1) and the process END 169 completes the routine, as the data-stream is transmitted as referenced in FIGS. 1, 2, 4a & 4b and 5b. The unit then would immediately return to deep-sleep as governed by the power management routines once the serial data-stream have been transmitted.

If the determination at RUN ROUTINE 162 is SENSOR ACTIVE PROCESS 170, then a USAGE SEQUENCE 172, a DENSITY SCORE 173, a DETERMINE INTERVAL 174, an AMPLITUDE STRENGTH 175, and a PREPARE USAGE DATA FOR STORAGE 176 is processed. These internal steps make some kind of meaning to the sensor signals coming-in from sensor control 38 and 234 referenced in FIGS. 1 and 2 respectively, and is directed to the OUTPUT TO NON-VOLATILE MEMORY 178 for permanent storage as an accumulation of logged usage that the tag reader 10 has experienced, as the dynamic representation of the usage. The routine END 180 completes the routine and the apparatus once again goes back to deep-sleep. A discussion on each of these signal processes (USAGE SEQUENCE 172, DENSITY SCORE 173, DETERMINE INTERVAL 174, AMPLITUDE STRENGTH 175, and PREPARE USAGE DATA FOR STORAGE 176) will be later in this disclosure.

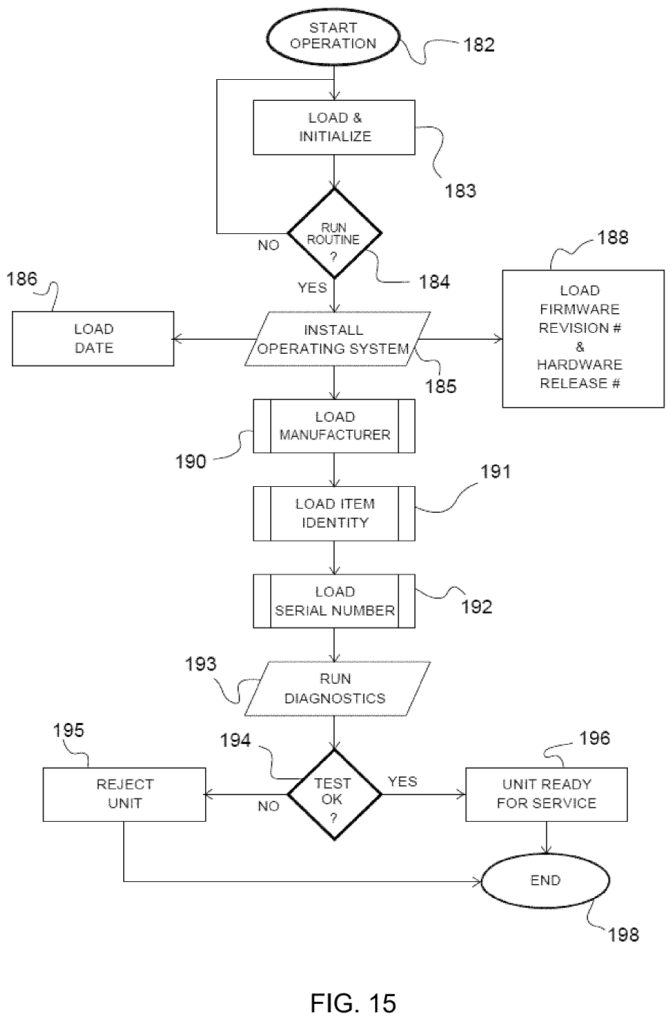

FIG. 15 is a flow diagram showing the process of a LOAD & INITIALIZE routines of the self-contained hermetically sealed electronic micro-controller for a smart tag 10, during the manufacturing process, and the testing thereof, in accordance with an embodiment of the present disclosure. A factory START OPERATIONS 182 begins with a LOAD & INITIALIZE 183. A query on starting the routine RUN ROUTINE-? 184, if ‘NO’ reverts back to starting point. Else if true, the ‘YES’ an INSTALL OPERATING SYSTEM 185, commences with a LOAD DATE 186 and LOAD FIRMWARE REVISION & HARDWARE RELEASE #188.

Following the installation of the operating system 185, a LOAD MANUFACTURER 190 (name), LOAD ITEM IDENTITY 191 (type, class or feature), LOAD SERIAL NUMBER 192. Each of these ‘loaded’ information info cells become permanently part of the serial data-stream and will be uploaded in such in all future queries of the smart tag 10, along with usage data as was disclosed in FIG. 11.

The factory initialization routine continues by entering a RUN DIAGNOSTICS 193 process. Where a full testing of functionality is accomplished, and a TEST OK-? is either ‘NO’ and the process is advance to the REJECT UNIT 195, and the apparatus is considered failed (not suitable for installation into an article to become a tag reader 10). Or, if tested OK. a ‘YES’ processes advanced to a UNIT READY FOR SERVICE 196, and the smart tag can be embedded into an article for monitoring as intended. The load and initialize routine END 198 with send the smart tag to deep-sleep, by the power management process, until needed for service.

In operation, the present disclosure of a self-contained hermetically sealed electronic micro-controller for a smart tag, having means to detect movement and wake-up from a power saving deep-sleep state, the wake-up action is a true sensed physical action of usage, not just simply that the article was being bumped (for example), determines if there is a query from a tag reader device, of logged activity, or an active sensor event to be logged as a dynamic representation of the usage to be stored. Whereby the apparatus either outputs the stored coded serial data-stream of logged usage information, or, processes the active sensor activity and stores such data in non-volatile memory respectively. After which, the apparatus would return to deep-sleep by the power management process.

The uploaded retrieved coded data-stream is decoded on a tag reader device running an application (APP) designed for the task. After the coded data-stream is ‘un-packed’ by the APP (see Table-1 for detail of the serial data-stream), the info is displayed on the tag reader. The usage data logged by the smart tag, is formatted on several useful screens of information about the article, that the apparatus is manufactured (embedded) into. Articles can be most anything manufactured; such as apparel items (a leather jacket, lady's dress or evening gown, etc.), accessory items (a women's purse, a leather belt, certain types of jewelry, etc.), footwear items (men's or women's athletic shoes, high heel shoes, golf shoes, etc.), mechanized items (bicycle, fishing rod, tennis racket, snowmobile, ski gear), etc.

During and when the tag reader is manufactured, there is a load & initialize process (this is accomplished by a special version of the tag reader and referenced in FIG. 15). Whereby, firmware is first downloaded into the operating system memory. Thereupon, the load date and firmware & hardware revision releases are also downloaded into the device, and, stored as permanent particulars of the intended article goods in which the smart tag is embedded. Also, an operation means could be part of a field programable gate array (FPGA) or other logic device suitable for holding the operation system of the smart tag; in a discrete design configuration.

When an article, the goods in which a smart tag is affixed to and installed/embedded in, can be queried by anyone having the application (APP) running on a tag reader (such as a cellphone) to see if the article is ‘NEW’ or not; along with the other manufacturing information. When the article is sold, the retailer would process the one-time-activation and make the smart tag functional as a usage monitoring device as indicated in earlier paragraphs stating such operations. The one-time-activation process is a restricted function, and can only be accomplished by authorized retailers using a special version of the tag reader and referenced in FIG. 8b and part of FIG. 13.

If the article is re-sold, at any time during the useful life of the article, either by retailers specializing in used goods, or by the current owner (even if the current owner is not the original owner), the smart tag can be queried, by anyone having access to the subject article of interest. All information is uploaded onto the tag reader doing the query, as referenced in FIGS. 3, 5, 6a, 7b, 10a, 10b, 11a, 11b, 13, and 14. The potential new purchaser can easily see the article's usage; the wear and tear, ‘mileage’ so to speak, and also know that the item is a genuine article by the manufacturer. The APP could further access the manufacturer data-base to match the serial number and manufactured date and coded information, via the Internet also operating on the tag reader (cellphone, etc.). The APP would compare the upload info from the smart tag to the corresponding info from the manufacturer's data-base about this exact article. Such access to an original manufacturer's server and data-base and comparison, would give definitive verification to the article's genuine authenticity, or, being a fake counterfeit article; in effect, making the smart tag 10 tamper-proof. The data-base access would be an option to the manufacturer of any particular goods, or series of goods (please remember that the smart tag has both high-end ‘pricy’ goods and lower priced more common goods, and, not all goods will have access to an on-going authentication needs).

Being that the smart tag is configured in a number of embodiments, intended for multiple end-use articles, some very pricy and some more common less expensive articles, the design has re-chargeable battery means or standard long-life battery means. The re-chargeable battery example as detailed in FIG. 1 can be recharged with wireless power transmission by simply placing the article on/near a charging station from time to time as necessary. The system of a smart tag also even logs when the battery is depleted (as a last possible entry before battery energy is empty, or, upon wake-up during a new charge of battery power); to track over the life of the unit, how many times it has experience the neglect of not recharging the battery.

In the case of a non-rechargeable battery, as in the example of FIG. 4, the smart tag logs usage events until the battery is exhausted, which is intended as the useful life of the article it is embedded in, and in most cases, the less expensive article. In either case, re-chargeable battery or non-rechargeable battery (or even a replaceable battery configuration), the ultra-low power operation, and deep-sleep power management capabilities, afford long stable life and allows articles items to be unattended for great periods of time (such as a leather jacket not being used and on a hanger in a closet).

In conclusion, the discussion of operation, a system and method for a smart tag, comprising a self-contained hermetically sealed electronic micro-controller for monitoring usage, when embedded into an article; the smart tag is intended to be fabricated into articles, to determine if the article is ‘NEW’, and if not new then ‘USED’, and, if used how much use has the article experienced in wear-and tear, where articles is an apparel item, an accessory item, a footwear item or a mechanical item.

The micro-controller is a processor, a firmware program, a non-volatile memory for data storage and logged usage in coded format, a sensing element, communications, and a battery power. The smart tag has a one-time-activation, to start a process of accumulating usage data, and the communications is between the smart tag and an tag reader running an application (APP) designed for interacting with the smart tag to display accumulated usage data, whereby a near field communications (NFC) technique affords very close-range transmission exchange.

The battery can be a re-chargeable battery for high-end articles or non-rechargeable battery of more common articles, wherein should the battery become depleted, the event is logged in non-volatile memory (either at last moment of shut-down, or at re-start when recharge or new battery is available). The non-volatile memory to store an article manufacturer's name, serial number and article product identity in coded format to conserve memory space, whereby such info conveys a genuine authentic article. The article product identity is an apparel item, an accessory item, a footwear item, or a mechanized item, wherein any such item can experience wear-and-tear and therefore be ideal for having a smart tag embedded therein.

The sensing element further contains a wake-up circuit, whereby upon wakeup (the wake-up action is a true sensed physical action of usage, not just simply that the article was being bumped, for example), the apparatus would respond to a query, or, be active for monitoring usage events. Wherein if the wakeup was for a query, the content of stored coded data and logged usage in non-volatile memory would be uploaded to said tag reader in serial data-stream format to be decoded and displayed. Else, if the wakeup was active monitoring of usage, usage event is logged by storing in the non-volatile memory. The usage monitoring event is parsed as a density, a sequence, an interval, and an amplitude algorithm as being representative of the degree of usage; performing a density to score the intensity of sensed signals, in the gauging the degree of usage; performing a sequence to tally the repetition of sensor activity, in monitoring the recurrence of usage; performing an interval to grade the time between signals, measure the gap-period; performing an amplitude to ascertain strength of a sensed signal, and scale any particular usage event. The result is to produce a ‘signature’ of the activity and log a dynamic representation of the usage being monitored. If neither a query nor active monitoring of usage event is needed, the apparatus would return to deep-sleep conserving battery power, until next wake-up occurs.

The apparatus and method, further comprises a charging station, wherein said charging is a wireless power transmission (WPT) technique for a re-chargeable battery, whereby inductive coupling, or resonance inductive coupling (RIC), recharging of the battery is accomplished at any time that the article, containing the smart tag, is in close proximity to the said charging station, said charging station can further facilitate communications via a carrier signal transmitted between the smart tag and the tag reader, of the serial data-stream as the apparatus is being charged.

Importantly, the sensing element is one or more of motion detection devices, such as a rolling ball switch, an accelerometer, a proximity magnetic switch, or a strain gauge means to detect movement of the article. The movement representing usage, and if not moving then article quiescent position is considered dormant. The sensing element(s) detects movement of the article and said movement is analyzed and categorized to a density, a sequence, an interval, and an amplitude algorithm of movement as being representative of the scale of usage.

The apparatus and method, features a one-time-activation process to determine if the article, an apparel item, an accessory item, a footwear item, or a mechanized item, that the apparatus is embedded/installed into during manufacturing, is ‘NEW’ or ‘USED’, and, if determination is ‘USED’, then log activity events represents the degree of usage as a density, a sequence, an interval, and an amplitude in an algorithm as being representative of the degree of usage the article has experienced as wear-and-tear. The wear-and-tear further may be a pseudo clock representing usage/days of operation logged and stored in non-volatile memory, whereby the usage/day is represented as an event of the article being used.

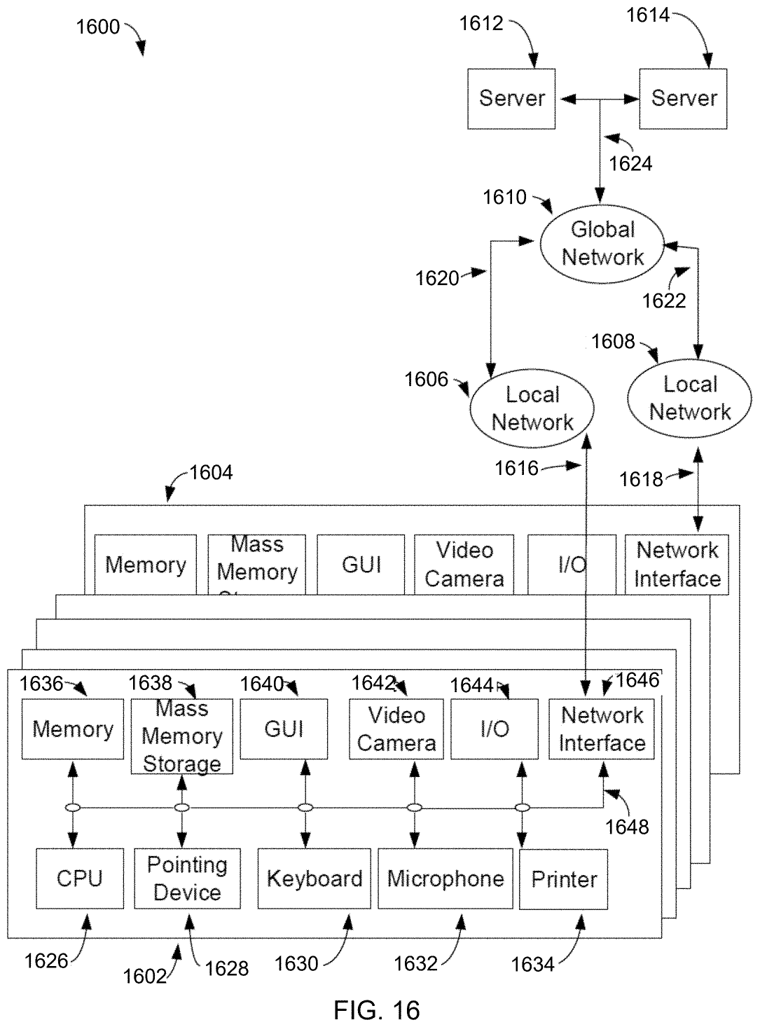

FIG. 16 is a block diagram depicting an exemplary client/server system which may be used by an exemplary web-enabled/networked embodiment of the present invention.

A communication system 1600 includes a multiplicity of clients with a sampling of clients denoted as a client 1602 and a client 1604, a multiplicity of local networks with a sampling of networks denoted as a local network 1606 and a local network 1608, a global network 1610 and a multiplicity of servers with a sampling of servers denoted as a server 1612 and a server 1614.

Client 1602 may communicate bi-directionally with local network 1606 via a communication channel 1616. Client 1604 may communicate bi-directionally with local network 1608 via a communication channel 1618. Local network 1606 may communicate bi-directionally with global network 1610 via a communication channel 1620. Local network 1608 may communicate bi-directionally with global network 1610 via a communication channel 1622. Global network 1610 may communicate bi-directionally with server 1612 and server 1614 via a communication channel 1624. Server 1612 and server 1614 may communicate bi-directionally with each other via communication channel 1624. Furthermore, clients 1602, 1604, local networks 1606, 1608, global network 1610 and servers 1612, 1614 may each communicate bi-directionally with each other.

In one embodiment, global network 1610 may operate as the Internet. It will be understood by those skilled in the art that communication system 1600 may take many different forms. Non-limiting examples of forms for communication system 1600 include local area networks (LANs), wide area networks (WANs), wired telephone networks, wireless networks, or any other network supporting data communication between respective entities.

Clients 1602 and 1604 may take many different forms. Non-limiting examples of clients 1602 and 1604 include personal computers, personal digital assistants (PDAs), cellular phones and smartphones.

Client 1602 includes a CPU 1626, a pointing device 1628, a keyboard 1630, a microphone 1632, a printer 1634, a memory 1636, a mass memory storage 1638, a GUI 1640, a video camera 1642, an input/output interface 1644 and a network interface 1646.

CPU 1626, pointing device 1628, keyboard 1630, microphone 1632, printer 1634, memory 1636, mass memory storage 1638, GUI 1640, video camera 1642, input/output interface 1644 and network interface 1646 may communicate in a unidirectional manner or a bi-directional manner with each other via a communication channel 1648. Communication channel 1648 may be configured as a single communication channel or a multiplicity of communication channels.

CPU 1626 may be comprised of a single processor or multiple processors. CPU 1626 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors.

As is well known in the art, memory 1636 is used typically to transfer data and instructions to CPU 1626 in a bi-directional manner. Memory 1636, as discussed previously, may include any suitable computer-readable media, intended for data storage, such as those described above excluding any wired or wireless transmissions unless specifically noted. Mass memory storage 1638 may also be coupled bi-directionally to CPU 1626 and provides additional data storage capacity and may include any of the computer-readable media described above. Mass memory storage 1638 may be used to store programs, data and the like and is typically a secondary storage medium such as a hard disk. It will be appreciated that the information retained within mass memory storage 1638, may, in appropriate cases, be incorporated in standard fashion as part of memory 1636 as virtual memory.

CPU 1626 may be coupled to GUI 1640. GUI 1640 enables a user to view the operation of computer operating system and software. CPU 1626 may be coupled to pointing device 1628. Non-limiting examples of pointing device 1628 include computer mouse, trackball and touchpad. Pointing device 1628 enables a user with the capability to maneuver a computer cursor about the viewing area of GUI 1640 and select areas or features in the viewing area of GUI 1640. CPU 1626 may be coupled to keyboard 1630. Keyboard 1630 enables a user with the capability to input alphanumeric textual information to CPU 1626. CPU 1626 may be coupled to microphone 1632. Microphone 1632 enables audio produced by a user to be recorded, processed and communicated by CPU 1626. CPU 1626 may be connected to printer 1634. Printer 1634 enables a user with the capability to print information to a sheet of paper. CPU 1626 may be connected to video camera 1642. Video camera 1642 enables video produced or captured by user to be recorded, processed and communicated by CPU 1626.

CPU 1626 may also be coupled to input/output interface 1644 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

Finally, CPU 1626 optionally may be coupled to network interface 1646 which enables communication with an external device such as a database or a computer or telecommunications or internet network using an external connection shown generally as communication channel 1616, which may be implemented as a hardwired or wireless communications link using suitable conventional technologies. With such a connection, CPU 1626 might receive information from the network, or might output information to a network in the course of performing the method steps described in the teachings of the present invention.

Because many modifications, variations, and changes in detail can be made to the described preferred embodiments of the disclosure, it is intended that all matters in the foregoing description and shown in the accompanying drawings be interpreted as illustrative and not in a limiting sense. Thus, the scope of the disclosure should be determined by the appended claims and their legal equivalence.

It is to be understood that the drawings and descriptive matter are in all cases to be interpreted as merely illustrative of the principles of the disclosure, rather than as limiting the same in any way, since it is contemplated that various changes may be made in various elements to achieve like results without departing from the spirit of the disclosure or the scope of the appended claims. All documents cited in the Detailed Description of the disclosure are, in relevant part, incorporated herein by reference; the citation of any document is not to be construed as an admission that it is prior art with respect to the present disclosure. To the extent that any meaning or definition of a term in this written document conflicts with any meaning or definition of the term in a document incorporated by reference, the meaning or definition assigned to the term in this written document shall govern.

These and other advantages of the invention will be further understood and appreciated by those skilled in the art by reference to the following written specification, claims and appended drawings.

Because many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What is claimed is:

1. A system for monitoring usage of an article, the system comprising:
a self-contained hermetically sealed electronic micro-controller for monitoring usage of an article, the micro-controller including at least one of the following: a processor, a firmware program, a non-volatile memory for data storage and logged usage in coded format, a sensing element, a communication protocol, and a battery,
the non-volatile memory operable to store an article manufacturer's name, serial number and article product identity in coded format, whereby such information indicates the authenticity of the article,
the battery being depletable, whereby if the battery depletes a depletion event is generated and logged into the non-volatile memory;
a smart tag embedded into the article, the smart tag operable to determine if the article is new or used, whereby if the article is used the smart tag determines the extent of usage, the smart tag having a one-time-activation to start a process of accumulating usage data;
an tag reader in wireless communication with the smart tag, whereby a near field communication protocol enables close-range transmission exchange, the communications between the smart tag and the tag reader, being a serial data-stream format of coded data,
whereby the communications between the smart tag and the tag reader enables running an application designed for interacting with the smart tag;
the sensing element containing a wake-up circuit operable to initiate a wakeup signal, whereby the wakeup signal actuates the smart tag to respond to a query from the tag reader, or activate for monitoring usage events;
whereby, if the wakeup signal is for the query, the content of stored coded data and logged usage in the non-volatile memory transmits to the tag reader in serial data-stream format;
whereby, if the wakeup was active monitoring of usage, the usage event is logged in the non-volatile memory;
whereby, the usage monitoring event is parsed as a density for scoring the intensity of sensed signals, a sequence for tallying the repetition of sensor activity, an interval for grading the time between signals, and an amplitude algorithm as being representative of a degree of usage to ascertain strength of a sensed signal; and
whereby if neither a query nor active monitoring of usage event is needed, the apparatus returns to a deep-sleep to conserve battery power, until next wake-up occurs.

2. The system of claim 1, further comprising a charging station, the charging being a wireless power transmission technique for a re-chargeable battery, such that recharging the battery can be accomplished at any time that the article, containing the smart tag, is in close proximity to the charging station.

3. The system of claim 1, wherein communications between the smart tag and the tag reader, is a serial data-stream format of coded data.

4. The system of claim 1, wherein the sensing element is a rolling ball switch or an accelerometer operable to detect movement of the article, the movement representing usage, and if not moving then its quiescent position is considered dormant, the rolling ball switch and the accelerometer detecting movement of the article and said movement is analyzed and categorized to the density, the sequence, the interval, and the amplitude algorithm of movement as being representative of a scale of usage.

5. The system of claim 1, wherein the one-time-activation process determines if the article is new or used.

6. The system of claim 5, wherein if the determination is used, one or more logged activity events represent the degree of usage of the item.

7. The system of claim 1, wherein the article includes at least one of the following: an apparel item, an accessory item, a footwear item, and a mechanical item.

8. A system for determining the condition of an article, the system comprising:
a smart tag having:
a non-volatile memory operable to store data related to an article, the data including at least one of the following: an article identity, a manufacturer, a serial number, and a date the smart tag attaches to the article;
a sensor element operatively connected to the non-volatile memory, the sensor element operable to detect a motion of the smart tag, the sensor element further being operable to log usage of the article if the duration of the motion exceeds a predetermined duration or intensity parameter,
the sensor element including a wake-up circuit operable to generate a wake-up signal upon detection of a query, the wake-up signal operable to enable retrieval of the data in the non-volatile memory in response to the query, the wake-up signal further being operable to enable logging usage of the article into the non-volatile memory;
a one-time-activation circuit operatively connected to the sensor element, the one-time-activation circuit operable to indicate that the article is new if the duration of the motion does not exceed the duration or intensity parameter, the one-time-activation circuit further being operable to indicate that the article is used if the duration of the motion exceeds the duration or intensity parameter; and
a tag reader operable to wirelessly communicate with the smart tag, the tag reader further being operable to initiate the query, the tag reader further being operable to display the queried data from the non-volatile memory, the tag reader further being operable to display whether the article is new or used.

9. The system of claim 8, wherein the article identity includes at least one of the following:
an apparel, an accessory, a footwear, and a mechanism.

10. The system of claim 8, wherein the smart tag is hermetically sealed, the smart tag further including at least one of the following: a micro-controller, a processor, and a firmware program.

11. The system of claim 8, wherein if the article is used, one or more activity events are generated and logged in the non-volatile memory, the activity events representing a degree of usage for the item.

12. The system of claim 8, wherein the sensor element comprises an ultra-low-power high-performance 3-axis accelerometer.

13. The system of claim 8, wherein the predetermined duration or intensity parameter is at least 10 seconds.

14. The system of claim 8, wherein the communication between the smart tag and the tag reader is a serial data-stream.

15. The system of claim 8, further comprising a sensor control operatively connected to the sensor element, the sensor control being operable to regulate the sensor element.

16. The system of claim 8, wherein the motion of the smart tag is categorized as a density comprising the intensity of the motion of the smart tag, a sequence comprising a tally of the repetition of motion of the smart tag, an interval comprising the time between different motions by the smart tag, and an amplitude algorithm of movement comprising the strength of the motion of the smart tag.

17. The system of claim 8, further comprising a battery.

18. The system of claim 17, wherein the battery, or the non-volatile memory, or both are in a deep sleep mode if there is no query.

19. A method for determining the condition of an article, the method comprising:
attaching a smart tag to an article, the smart tag comprising a non-volatile memory, a sensor element operatively connected to the non-volatile memory and having a wake-up circuit, and a one-time-activation circuit operatively connected to the sensor element;
loading data related to the article on the non-volatile memory;
maintaining the smart tag in a deep sleep mode until a wake-up signal is transmitted by the wake-up circuit;
detecting, with the sensor element, a motion of the smart tag;
logging, by the sensor element, usage of the article if the duration of the motion exceeds a predetermined duration or intensity parameter;
indicating, by the one-time-activation circuit, that the article is new if the duration of the motion does not exceed the duration or intensity parameter;
indicating, by the one-time-activation circuit, that the article is used if the duration of the motion exceeds the duration or intensity parameter;
initiating, by a tag reader, a query for the data; and
enabling, by the wake-up signal, retrieval of the data in the non-volatile memory in response to the query.

20. The method of claim 19, wherein the motion of the smart tag is categorized as a density comprising the intensity of the motion of the smart tag, a sequence comprising a tally of the repetition of motion of the smart tag, an interval comprising the time between different motions by the smart tag, and an amplitude algorithm of movement comprising the strength of the motion of the smart tag.
